(19) United States
(12) Patent Application Publication
(10) Pub. No.: US 2014/0184871 A1
(43) Pub. Date: Jul. 3, 2014

(54) MOBILE DEVICE AND OPTICAL IMAGING LENS THEREOF

(71) Applicant: GENIUS ELECTRONIC OPTICAL CO., LTD., Taichung City (TW)

(72) Inventors: Shih-Han CHEN, Taichung City (TW); Chia-Cheng LIN, Taichung City (TW); Zheng-Chao YUAN, Xiamen (CN); Chien Jui LIN, Taichung City (TW)

(73) Assignee: Genius Electronic Optical Co., Ltd., Taichung City (TW)

(21) Appl. No.: 13/847,461

(22) Filed: Mar. 19, 2013

(30) Foreign Application Priority Data
Dec. 28, 2012 (CN) 201210583225.5

(51) Int. Cl. H04N 5/225; G02B 9/34

(52) U.S. Cl. CPC H04N 5/2254; G02B 9/34
USPC 348/335; 359/771

(57) ABSTRACT

Present embodiments provide for a mobile device and an optical imaging lens thereof. The optical imaging lens comprises four lens elements positioned sequentially from an object side to an image side. Though controlling the convex or concave shape of the surfaces, the refraction power and/or the ratio among the parameters of the lens element(s), the optical imaging lens shows better optical characteristics and the total length of the optical imaging lens is shortened.

### INCORPORATION BY REFERENCE

This application claims priority from P.R.C Patent Application No. 201210583225.5, filed on Dec. 28, 2012, the contents of which are hereby incorporated by reference in their entirety for all purposes.

### TECHNICAL FIELD

The present invention relates to a mobile device and an optical imaging lens thereof, and particularly, relates to a mobile device applying an optical imaging lens having four lens elements and an optical imaging lens thereof.

### BACKGROUND

The ever-increasing demand for smaller sized mobile devices, such as cell phones, digital cameras, etc. has correspondingly triggered a growing need for a smaller sized photography module (comprising elements such as an optical imaging lens, a module housing unit, and an image sensor, etc.) contained therein. Size reductions may be contributed from various aspects of the mobile devices, which includes not only the charge coupled device (CCD) and the complementary metal-oxide semiconductor (CMOS), but also the optical imaging lens mounted therein. When reducing the size of the optical imaging lens, however, achieving good optical characteristics becomes a challenging problem.

U.S. Pat. No. 7,274,518, U.S. Pat. No. 7,453,654, U.S. Pat. No. 8,184,383, R.O.C. Patent No. M356917, and R.O.C. Patent Publication No. 201224568, R.O.C. Patent Publication No. 201217852, R.O.C. Patent Publication No. 201020583 and R.O.C. Patent Publication No. 201215941 all disclosed an optical imaging lens constructed with an optical imaging lens having four lens elements, wherein the second lens element is thicker than other lens elements.

The sum of the three air gaps between the lens elements is excessive in the optical imaging lens of U.S. Pat. No. 7,920,340, U.S. Pat. No. 7,777,972, and U.S. Patent Publication No. 20110058089 and R.O.C. Patent Publication No. 200815785, R.O.C. Patent Publication No. 201116847, constructed with an optical imaging lens having four lens elements. For example, the lengths of some imaging lens of R.O.C. Patent Publication No. 201116847 reaches 7 mm. Such configuration fails to achieve preferable small size of the whole system.

Therefore, there is needed to develop optical imaging lens with a shorter length, while also having good optical characters.

### SUMMARY

An object of the present invention is to provide a mobile device and an optical imaging lens thereof. With controlling the convex or concave shape and/or the refracting power of the lens element(s), the length of the optical imaging lens is shortened and meanwhile the good optical characters, and system functionality are sustained.

In an exemplary embodiment, an optical imaging lens comprises, sequencially from an object side to an image side, comprises first, second, third and fourth lens elements, each of said first, second, third and fourth lens elements having an object-side surface facing toward the object side and an image-side surface facing toward the image side, wherein: the first lens element has positive refracting power, the object-side surface thereof is a convex surface, and the image-side thereof comprises a concave portion in a vicinity of the optical axis; the second lens element has negative refracting power, and the object-side surface thereof comprises a convex portion in a vicinity of a periphery of the second lens element; the image-side surface of the third lens element comprises a convex portion in a vicinity of a periphery of the third lens element; the object-side surface of the fourth lens element comprises a convex portion in a vicinity of the optical axis, and the image-side surface of the fourth lens element comprises a concave portion in a vicinity of the optical axis and a convex portion in a vicinity of a periphery of the fourth lens element; lens as a whole has only the four lens elements having refracting power.

In another exemplary embodiment, at least one equation for restricting the ratio among some parameters can be taken into consideration. For example, a central thickness of the first lens element along the optical axis, T1, and an air gap between the first lens element and the second lens element along the optical axis, G12, could be controlled to satisfy the equation as follows:

5≦T1/G12 Equation (1); or

A central thickness of the fourth lens element along the optical axis, T4, and an air gap between the third lens element and the fourth lens element along the optical axis, G34, could be controlled to satisfy the equation as follows:

T4/G34≦4 Equation (2); or

A central thickness of the second lens element along the optical axis, T2, and a central thickness of the third lens element along the optical axis, T3, could be controlled to satisfy the equation as follows:

1.55≦T3/T2 Equation (3); or

G12 and an air gap between the second lens element and the third lens element along the optical axis, G23, could be controlled to satisfy the equation (s) as follows:

3≦G23/G12 Equation (4); or

T2 and T4 could be controlled to satisfy the equation as follows:

1.45≦T4/T2 Equation (5); or

1.8≦T4/T2 Equation (5′); or

G12, G23 and G34 could be controlled to satisfy the equation (s) as follows:

7.5≦(G23+G34)/G12 Equation (6); or

The sum of all three air gaps from the first lens element to the fourth lens element along the optical axis is Gaa and T2 could be controlled to satisfy the equation as follows:

3.2≦Gaa/T2 Equation (7).

Aforesaid exemplary embodiments are not limited and could be selectively incorporated in other embodiments described herein.

In some exemplary embodiments, more details about the convex or concave surface structure could be incorporated for one specific lens element or broadly for plural lens elements to enhance the control for the system performance and/or resolution. For example, the image-side surface of the first lens element could comprise a concave portion in a vicinity of a periphery of the first lens element.

In another exemplary embodiment, a mobile device comprising a housing and a photography module positioned in the housing is provided. The photography module comprises any of aforesaid example embodiments of optical imaging lens, a lens barrel, a module housing unit, and an image sensor. The lens barrel is for positioning the optical imaging lens, the module housing unit is for positioning the lens barrel, and the image sensor is positioned at the image-side of the optical imaging lens.

In some exemplary embodiments, the module housing unit optionally comprises a lens backseat. The lens backseat exemplarily comprises a first seat element and a second seat element, the first seat element is positioned close to the outside of the lens barrel and along with an axis for driving the lens barrel and the optical imaging lens positioned therein to move along the axis, and the second seat element is positioned along the axis and around the outside of the first seat element. The module housing unit could optionally further comprises an image sensor base positioned between the second seat element and the image sensor, and the image sensor base is closed to the second seat element.

Through controlling the convex or concave shape of the surfaces, the refraction power and/or the ratio or difference among the parameters of the lens element(s), the mobile device and the optical imaging lens thereof in exemplary embodiments achieve good optical characters and effectively shorten the length of the optical imaging lens.

### BRIEF DESCRIPTION OF THE DRAWINGS

Exemplary embodiments will be more readily understood from the following detailed description when read in conjunction with the appended drawing, in which:

FIG. 1 is a cross-sectional view of a first embodiment of an optical imaging lens having four lens elements according to the present disclosures;

FIG. 2 is a chart of longitudinal spherical aberration and other kinds of optical aberrations of a first embodiment of the optical imaging lens according to the present disclosures;

FIG. 3 is a cross-sectional view of a lens element of the optical imaging lens of an example embodiment of the present disclosures;

FIG. 4 is a table of optical data for each lens element of a first embodiment of an optical imaging lens according to the present disclosures;

FIG. 5 is a table of aspherical data of a first embodiment of the optical imaging lens according to the present disclosures;

FIG. 6 is a cross-sectional view of a second embodiment of an optical imaging lens having four lens elements according to the present disclosures;

FIG. 7 is a chart of longitudinal spherical aberration and other kinds of optical aberrations of a second embodiment of the optical imaging lens according to the present disclosures;

FIG. 8 is a table of optical data for each lens element of the optical imaging lens of a second embodiment of the present disclosures;

FIG. 9 is a table of aspherical data of a second embodiment of the optical imaging lens according to the present disclosures;

FIG. 10 is a cross-sectional view of a third embodiment of an optical imaging lens having four lens elements according to the present disclosures;

FIG. 11 is a chart of longitudinal spherical aberration and other kinds of optical aberrations of a third embodiment of the optical imaging lens according the present disclosures;

FIG. 12 is a table of optical data for each lens element of the optical imaging lens of a third embodiment of the present disclosures;

FIG. 13 is a table of aspherical data of a third embodiment of the optical imaging lens according to the present disclosures;

FIG. 14 is a cross-sectional view of a fourth embodiment of an optical imaging lens having four lens elements according to the present disclosures;

FIG. 15 is a chart of longitudinal spherical aberration and other kinds of optical aberrations of a fourth embodiment of the optical imaging lens according the present disclosures;

FIG. 16 is a table of optical data for each lens element of the optical imaging lens of a fourth embodiment of the present disclosures;

FIG. 17 is a table of aspherical data of a fourth embodiment of the optical imaging lens according to the present disclosures;

FIG. 18 is a cross-sectional view of a fifth embodiment of an optical imaging lens having four lens elements according to the present disclosures;

FIG. 19 is a chart of longitudinal spherical aberration and other kinds of optical aberrations of a fifth embodiment of the optical imaging lens according the present disclosures;

FIG. 20 is a table of optical data for each lens element of the optical imaging lens of a fifth embodiment of the present disclosures;

FIG. 21 is a table of aspherical data of a fifth embodiment of the optical imaging lens according to the present disclosures;

FIG. 22 is a cross-sectional view of a sixth embodiment of an optical imaging lens having four lens elements according to the present disclosures;

FIG. 23 is a chart of longitudinal spherical aberration and other kinds of optical aberrations of a sixth embodiment of the optical imaging lens according the present disclosures;

FIG. 24 is a table of optical data for each lens element of the optical imaging lens of a sixth embodiment of the present disclosures;

FIG. 25 is a table of aspherical data of a sixth embodiment of the optical imaging lens according to the present disclosures;

FIG. 26 is a cross-sectional view of a seventh embodiment of an optical imaging lens having four lens elements according to the present disclosures;

FIG. 27 is a chart of longitudinal spherical aberration and other kinds of optical aberrations of a seventh embodiment of the optical imaging lens according the present disclosures;

FIG. 28 is a table of optical data for each lens element of the optical imaging lens of a seventh embodiment of the present disclosures;

FIG. 29 is a table of aspherical data of a seventh embodiment of the optical imaging lens according to the present disclosures;

FIG. 30 is a cross-sectional view of a eighth embodiment of an optical imaging lens having four lens elements according to the present disclosures;

FIG. 31 is a chart of longitudinal spherical aberration and other kinds of optical aberrations of a eighth embodiment of the optical imaging lens according the present disclosures;

FIG. 32 is a table of optical data for each lens element of the optical imaging lens of a eighth embodiment of the present disclosures;

FIG. 33 is a table of aspherical data of a eighth embodiment of the optical imaging lens according to the present disclosures;

FIG. 34 is a cross-sectional view of a ninth embodiment of an optical imaging lens having four lens elements according to the present disclosures;

FIG. 35 is a chart of longitudinal spherical aberration and other kinds of optical aberrations of a ninth embodiment of the optical imaging lens according the present disclosures;

FIG. 36 is a table of optical data for each lens element of the optical imaging lens of a ninth embodiment of the present disclosures;

FIG. 37 is a table of aspherical data of a ninth embodiment of the optical imaging lens according to the present disclosures;

FIG. 38 is a cross-sectional view of a tenth embodiment of an optical imaging lens having four lens elements according to the present disclosures;

FIG. 39 is a chart of longitudinal spherical aberration and other kinds of optical aberrations of a tenth embodiment of the optical imaging lens according the present disclosures;

FIG. 40 is a table of optical data for each lens element of the optical imaging lens of a tenth embodiment of the present disclosures;

FIG. 41 is a table of aspherical data of a tenth embodiment of the optical imaging lens according to the present disclosures;

FIG. 42 is a cross-sectional view of a eleventh embodiment of an optical imaging lens having four lens elements according to the present disclosures;

FIG. 43 is a chart of longitudinal spherical aberration and other kinds of optical aberrations of a eleventh embodiment of the optical imaging lens according the present disclosures;

FIG. 44 is a table of optical data for each lens element of the optical imaging lens of a eleventh embodiment of the present disclosures;

FIG. 45 is a table of aspherical data of a eleventh embodiment of the optical imaging lens according to the present disclosures;

FIG. 46 is a table for the values of T1, G12, T2, G23, T3, G34, T4, Gaa, T4/G34, T4/T2, Gaa/T2, G23/G12, T1/G12, (G23+G34)/G12 and T3/T2 of all eleven example embodiments;

FIG. 47 is a structure of an example embodiment of a mobile device;

FIG. 48 is a partially enlarged view of the structure of another example embodiment of a mobile device.

### DETAILED DESCRIPTION

For a more complete understanding of the present disclosure and its advantages, reference is now made to the following description taken in conjunction with the accompanying drawings, in which like reference numbers indicate like features. Persons having ordinary skill in the art will understand other varieties for implementing example embodiments, including those described herein. The drawings are not limited to specific scale and similar reference numbers are used for representing similar elements. As used in the disclosures and the appended claims, the terms “example embodiment,” “exemplary embodiment,” and “present embodiment” do not necessarily refer to a single embodiment, although it may, and various example embodiments may be readily combined and interchanged, without departing from the scope or spirit of the present invention. Furthermore, the terminology as used herein is for the purpose of describing example embodiments only and is not intended to be a limitation of the invention. In this respect, as used herein, the term “in” may include “in” and “on”, and the terms “a”, “an” and “the” may include singular and plural references. Furthermore, as used herein, the term “by” may also mean “from”, depending on the context. Furthermore, as used herein, the term “if” may also mean “when” or “upon”, depending on the context. Furthermore, as used herein, the words “and/or” may refer to and encompass any and all possible combinations of one or more of the associated listed items.

Example embodiments of an optical imaging lens may comprise a first lens element, a second lens element, a third lens element and a fourth lens element, each of the lens elements has an object-side surface facing toward the object side and an image-side surface facing toward the image side. These lens elements may be arranged sequencially from an object side to an image side, and example embodiments of the lens as a whole may comprise the four lens elements having refracting power. In an example embodiment: the first lens element has positive refracting power, the object-side surface thereof is a convex surface, and the image-side thereof comprises a concave portion in a vicinity of the optical axis; the second lens element has negative refracting power, and the object-side surface thereof comprises a convex portion in a vicinity of a periphery of the second lens element; the image-side surface of the third lens element comprises a convex portion in a vicinity of a periphery of the third lens element; the object-side surface of the fourth lens element comprises a convex portion in a vicinity of the optical axis, and the image-side surface of the fourth lens element comprises a concave portion in a vicinity of the optical axis and a convex portion in a vicinity of a periphery of the fourth lens element.

Preferably, the lens elements are designed in light of the optical characteristics and the length of the optical imaging lens. For example, the first lens element having positive refracting power and a convex object-side surface provides the light converge ability required in the optical imaging lens. If the first lens element is companied with the details on the surface(s), such as a concave portion in a vicinity of the optical axis on the image-side thereof or further with a concave portion in a vicinity of a periphery of the first lens element on the image-side thereof, the astigmatism aberration of the optical lens will be adjusted. The second lens element having negative refracting power and a convex portion in a vicinity of a periphery of the second lens element on the object-side thereof together with the third lens element having a convex portion in a vicinity of a periphery of the third lens element on the image-side thereof could eliminate the chromatic aberration and curvature of the optical lens. Additionally, the fourth lens element designed to have a convex portion in a vicinity of the optical axis on the object-side thereof, a concave portion in a vicinity of the optical axis and a convex portion in a vicinity of a periphery of the fourth lens element on the image-side thereof and could assist in adjusting the curvature, reducing the high level aberration, and depressing the angle of the chief ray (the incident angle of the light onto the image sensor). All these details could promote the image quality of the whole system.

In another exemplary embodiment, at least one equation for restricting ratio among some related parameters could be optionally incorporated. For example, a central thickness of the first lens element along the optical axis, T1, and an air gap between the first lens element and the second lens element along the optical axis, G12, could be controlled to satisfy the equation as follows:

5≦T1/G12 Equation (1); or

A central thickness of the fourth lens element along the optical axis, T4, and an air gap between the third lens element and the fourth lens element along the optical axis, G34, could be controlled to satisfy the equation as follows:

T4/G34≦4 Equation (2); or

A central thickness of the second lens element along the optical axis, T2, and a central thickness of the third lens element along the optical axis, T3, could be controlled to satisfy the equation as follows:

1.55≦T3/T2 Equation (3); or

G12 and an air gap between the second lens element and the third lens element along the optical axis, G23, could be controlled to satisfy the equation (s) as follows:

3≦G23/G12 Equation (4); or

T2 and T4 could be controlled to satisfy the equation as follows:

1.45≦T4/T2 Equation (5); or

1.8≦T4/T2 Equation (5′); or

G12, G23 and G34 could be controlled to satisfy the equation (s) as follows:

7.5≦(G23+G34)/G12 Equation (6); or

The sum of all three air gaps from the first lens element to the fourth lens element along the optical axis is Gaa and T2 could be controlled to satisfy the equation as follows:

3.2≦Gaa/T2 Equation (7).

Aforesaid exemplary embodiments are not limited and could be selectively incorporated in other embodiments described herein.

Reference is now made to equation (1). The value of T1/G12 is preferrable to greater than or equal to 5 to satisfy equation (1). This is because the first lens element is required for providing light coverage ability, therefore the thickness thereof is not too thin and the possibility to shorten the thickness thereof is limited. Additionally, the value of T1/G12 is suggested to within 5˜20, i.e. 5≦T1/G12≦20.

Reference is now made to equation (2). The value of T4/G34 is preferrable no greater than or equal to 4 to satisfy equation (2) for a better configuration of T4 and G34 when shortening the length of the optical lens. This is because a greater distance between the third and fourth lens elements could disperse light onto a proper level, which will improve the image quality. Additionally, it is suggested that the value of T4/G34 is suggested to within 0.5˜4, i.e. 0.5≦T4/G34≦4.

Reference is now made to equation (3). The value of T3/T2 is preferrable greater than or equal to 1.55 to satisfy equation (3) for easier production. This is because the diameter for passing light in the third lens element is larger than that in the second lens element, which has negative refracting power. Additionally, it is suggested that the value of T3/T2 should not too large, preferably, between 1.55˜3.0, i.e. 1.55≦T3/T2≦3.0.

Reference is now made to equation (4). The value of G23/G12 is preferrable greater than or equal to 3 to satisfy equation (4). This is because between two lens element having similar diameter for passing light, such as the first and second lens element, is not required for a great air gap to disperse light onto a proper level. Hence, G12 could be shortened more than G23. Additionally, it is suggested that the value of G23/G12 should not too large, preferably, between 3˜22, i.e. 3≦G23/G12≦22.

Reference is now made to equation (5). The value of T4/T2 is preferrable greater than or equal to 1.45 to satisfy equation (5). This is because a proper ratio between the thicknesses of the second and fourth lens elements is favorable for production, since the diameter for passing light in the second lens element is smaller than that in the fourth lens element and the refracting power of the second lens element is negative. When 1.45≦T4/T2≦1.8 is satisfied, the length of the optical lens is shortened and optical characters are sustained; however, when equation (5′) is satisfied, the relatively thicker fourth lens element could be easier made. Additionally, it is suggested that the value of T4/T2 should not too large, preferably, between 1.45˜4.30, i.e. 1.45≦T4/T2≦4.30.

Reference is now made to equation (6). The value of (G23+G34)/G12 is preferrable greater than or equal to 7.5 to satisfy equation (6) for a better configuration of each air gap. Preferably, the value of (G23+G34)/G12 should not too large, such as within 7.5˜28, i.e. 7.5≦(G23+G34)/G12≦28.

Reference is now made to equation (7). The value of Gaa/T2 is preferrable greater than or equal to 3.2 to satisfy equation (7) for shortening the thickness of the second lens element more. This is because the thickness of the second lens element could be shortened relatively more than the sum of all air gaps for the small diameter for passing light in the second lens element and negative refracting power thereof. Additionally, it is suggested that the value of Gaa/T2 should not too small, preferably, between 3.2˜4.7, i.e. 3.2≦Gaa/T2≦4.7.

When implementing example embodiments, more details about the convex or concave surface structure and/or the refracting power may be incorporated for one specific lens element or broadly for plural lens elements to enhance the control for the system performance and/or resolution, as illustrated in the following embodiments. It is noted that the details listed here could be incorporated in example embodiments if no inconsistency occurs.

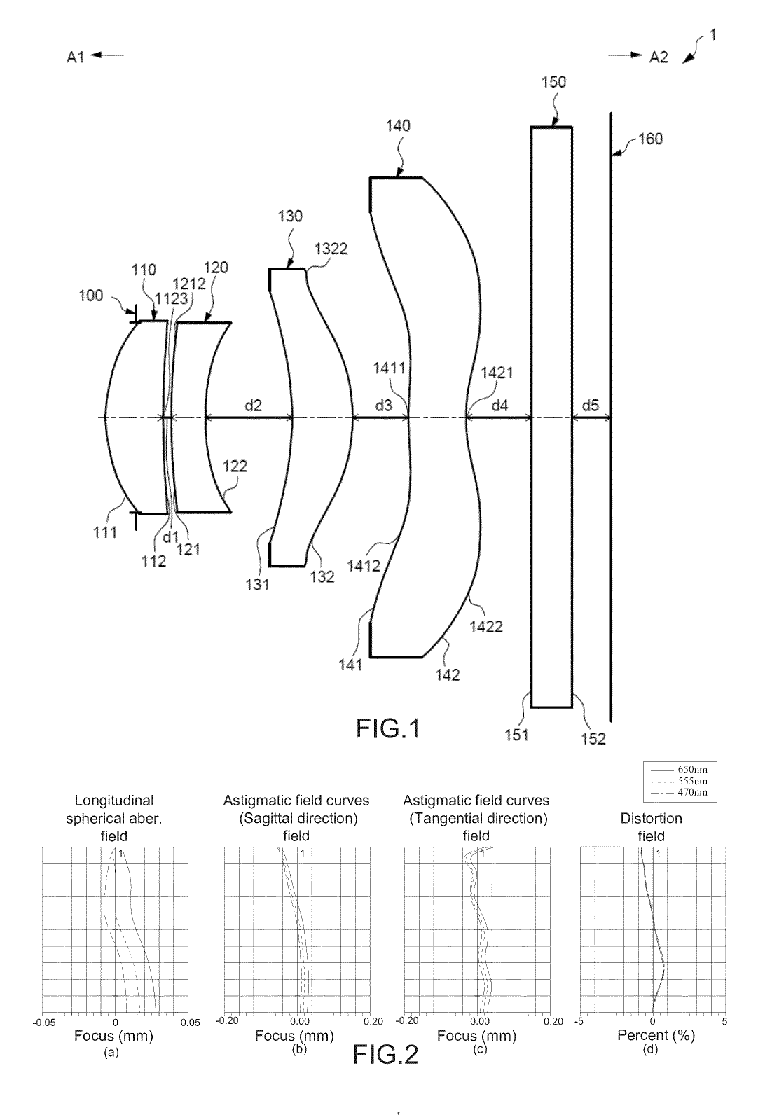

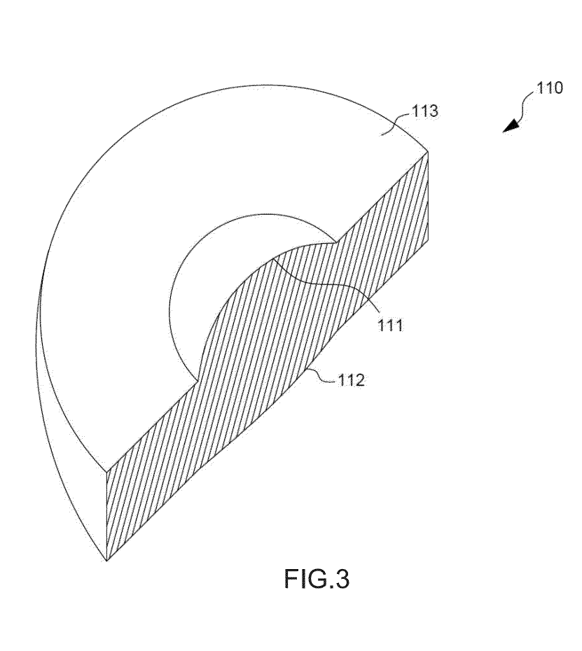

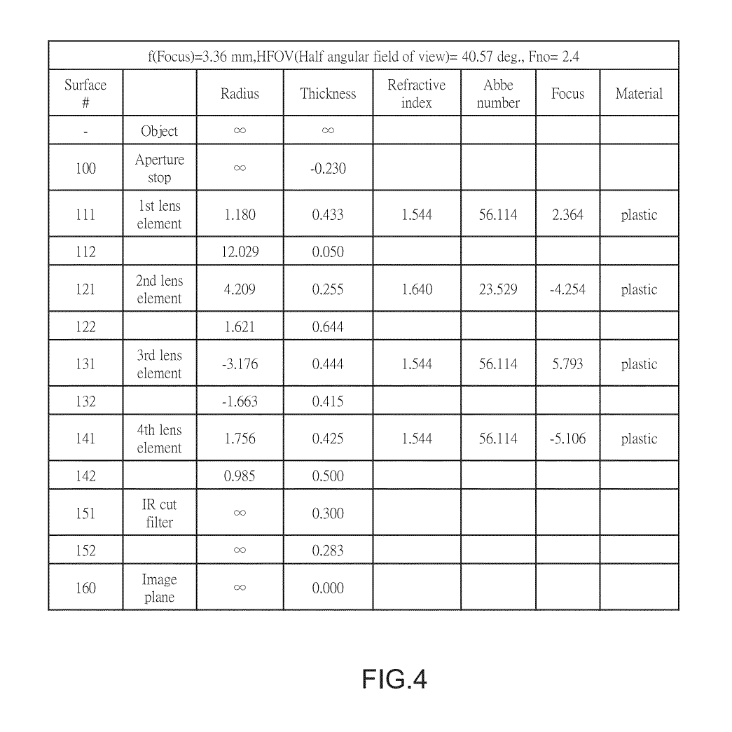

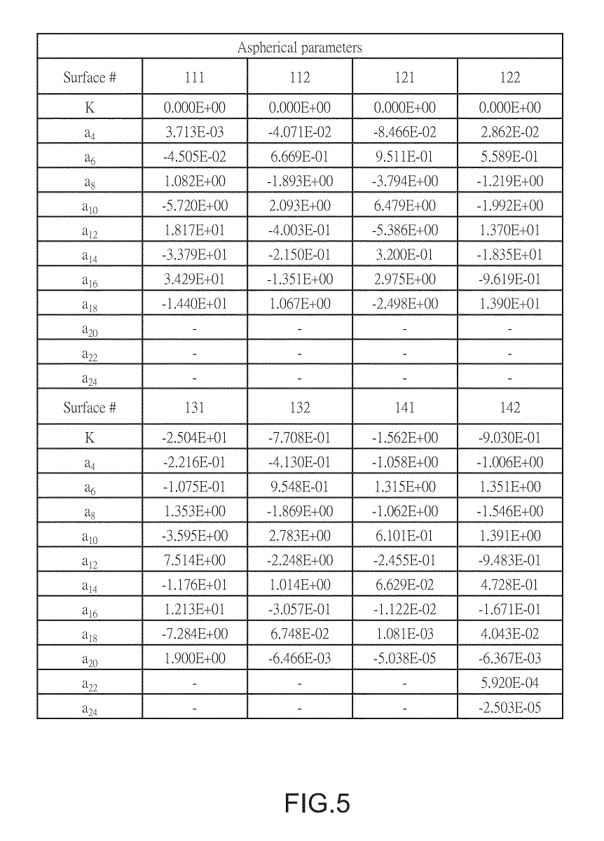

Several exemplary embodiments and associated optical data will now be provided for illustrating example embodiments of optical imaging lens with good optical characters and a shortened length. Reference is now made to FIGS. 1-5. FIG. 1 illustrates an example cross-sectional view of an optical imaging lens 1 having four lens elements of the optical imaging lens according to a first example embodiment. FIG. 2 shows example charts of longitudinal spherical aberration and other kinds of optical aberrations of the optical imaging lens 1 according to an example embodiment. FIG. 3 depicts another example cross-sectional view of a lens element of the optical imaging lens 1 according to an example embodiment. FIG. 4 illustrates an example table of optical data of each lens element of the optical imaging lens 1 according to an example embodiment. FIG. 5 depicts an example table of aspherical data of the optical imaging lens 1 according to an example embodiment.

As shown in FIG. 1, the optical imaging lens 1 of the present embodiment comprises, in order from an object side A1 to an image side A2, an aperture stop 100 positioned before a first lens element 110, the first lens element 110, a second lens element 120, a third lens element 130 and a fourth lens element 140. A filtering unit 150 and an image plane 160 of an image sensor are positioned at the image side A2 of the optical lens 1. Each of the first, second, third, and fourth lens elements 110, 120, 130, 140 and the filtering unit 150 has an object-side surface 111/121/131/141/151 facing toward the object side A1 and an image-side surface 112/122/132/142/152 facing toward the image side A2. The example embodiment of the filtering unit 150 illustrated is an IR cut filter (infrared cut filter) positioned between the fourth lens element 140 and an image plane 160. The filtering unit 150 filters light with specific wavelength from the light passing optical imaging lens 1. For example, IR light is filtered, and this will prohibit the IR light which is not seen by human eyes from producing an image on the image plane 160.

Exemplary embodiments of each lens elements of the optical imaging lens 1 will now be described with reference to the drawings.

An example embodiment of the first lens element 110 may have positive refracting power, which may be constructed by plastic material. The object-side surface 111 is a convex surface. The image-side surface 112 is a concave surface having a concave portion 1123 in a vicinity of the optical axis.

The second lens element 120 may have negative refracting power, which may be constructed by plastic material. The object-side surface 121 is a convex surface having a convex portion 1212 in a vicinity of a periphery of the second lens element 120. The image-side surface 122 is a concave surface.

The third lens element 130 may have positive refracting power, which may be constructed by plastic material. The object-side surface 131 is a concave surface. The image-side surface 132 is a convex surface having a convex portion 1322 in a vicinity of a periphery of the third lens element 130.

The fourth lens element 140 may have negative refracting power, which may be constructed by plastic material. The object-side surface 141 has a convex portion 1411 in a vicinity of the optical axis and a concave portion 1412 in a vicinity of a periphery of the fourth lens element 140. The image-side surface 142 has a concave portion 1421 in a vicinity of the optical axis and a convex portion 1422 in a vicinity of a periphery of the fourth lens element 140.

In example embodiments, air gaps exist between the lens elements 110, 120, 130, 140, the filtering unit 150, and the image plane 160 of the image sensor. For example, FIG. 1 illustrates the air gap d1 existing between the first lens element 110 and the second lens element 120, the air gap d2 existing between the second lens element 120 and the third lens element 130, the air gap d3 existing between the third lens element 130 and the fourth lens element 140, the air gap d4 existing between the fourth lens element 140 and the filtering unit 150, and the air gap d5 existing between the filtering unit 150 and the image plane 160 of the image sensor. However, in other embodiments, any of the aforesaid air gaps may or may not exist. For example, the profiles of opposite surfaces of any two adjacent lens elements may correspond to each other, and in such situation, the air gaps may not exist. The air gap d1 is denoted by G12, the air gap d3 is denoted by G34, and the sum of all air gaps d1, d2, d3 between the first and fourth lens elements 110, 140 is denoted by Gaa.

FIG. 4 depicts the optical characters of each lens elements in the optical imaging lens 1 of the present embodiment, wherein the values of T1/G12, T4/G34, T3/T2, G23/G12, T4/T2, (G23+G34)/G12 and Gaa/T2 are:

T1/G12=8.67, satisfying equation (1);

T4/G34=1.02, satisfying equation (2);

T3/T2=1.74, satisfying equation (3);

G23/G12=12.89, satisfying equation (4);

T4/T2=1.67, satisfying equation (5);

(G23+G34)/G12=21.17, satisfying equation (6);

Gaa/T2=4.35, satisfying equation (7);

wherein the distance from the object-side surface 111 of the first lens element 110 to the image plane 160 on the optical axis is 3.75 (mm), and the length of the optical imaging lens 1 is shortened.

Please note that, in example embodiments, to clearly illustrate the structure of each lens element, only the part where light passes, is shown. For example, taking the first lens element 110 as an example, FIG. 1 illustrates the object-side surface 111 and the image-side surface 112. However, when implementing each lens element of the present embodiment, a fixing part for positioning the lens elements inside the optical imaging lens 1 may be formed selectively. Based on the first lens element 110, please refer to FIG. 3, which illustrates the first lens element 110 further comprising a fixing part. Here the fixing part is not limited to a protruding part 113 extending from the object-side surface 111 and the image-side surface 112 for mounting the first lens element 110 in the optical imaging lens 1, and ideally, light will not pass through the protruding part 113.

The aspherical surfaces, including the object-side surface 111 and the image-side surface 112 of the first lens element 110, the object-side surface 121 and the image-side surface 122 of the second lens element 120, the object-side surface 131 and the image-side surface 132 of the third lens element 130, and the object-side surface 141 and the image-side surface 142 of the fourth lens element 140 are all defined by the following aspherical formula:

$$Z ( Y ) = \frac{{Y}^{2}}{R} / ( 1 + \sqrt{1 - ( 1 + K ) \frac{{Y}^{2}}{{R}^{2}}} ) + {\sum }_{i = 1}^{n} {a}_{2 i} \times {Y}^{2 i}$$

wherein,

R represents the radius of the surface of the lens element;

Z represents the depth of the aspherical surface (the perpendicular distance between the point of the aspherical surface at a distance Y from the optical axis and the tangent plane of the vertex on the optical axis of the aspherical surface);

Y represents the perpendicular distance between the point of the aspherical surface and the optical axis;

K represents a conic constant;

a₂ᵢ represents a aspherical coefficient of 2i^{th} level.

The values of each aspherical parameter are shown in FIG. 5.

As illustrated in FIG. 2, longitudinal spherical aberration (a), the curves of different wavelengths are closed to each other. This represents off-axis light with respect to these wavelengths is focused around an image point. From the vertical deviation of each curve shown therein, the offset of the off-axis light relative to the image point is within ±0.03 (mm). Therefore, the present embodiment improves the longitudinal spherical aberration with respect to different wavelengths.

Please refer to FIG. 2, astigmatism aberration in the sagittal direction (b) and astigmatism aberration in the tangential direction (c). The focus variation with respect to the three wavelengths in the whole field falls within ±0.10 (mm). This reflects the optical imaging lens 1 of the present embodiment eliminates aberration effectively. Additionally, the closed curves represents dispersion is improved.

Please refer to FIG. 2, distortion aberration (d), which showing the variation of the distortion aberration is within ±1%. Such distortion aberration meets the requirement of acceptable image quality and shows the optical imaging lens 1 of the present embodiment could restrict the distortion aberration to raise the image quality even though the length of the optical imaging lens 1 is shortened to 3.75 mm.

Therefore, the optical imaging lens 1 of the present embodiment shows great characteristics in the longitudinal spherical aberration, astigmatism in the sagittal direction, astigmatism in the tangential direction, and distortion aberration. According to above illustration, the optical imaging lens 1 of the example embodiment indeed achieves great optical performance and the length of the optical imaging lens 1 is effectively shortened.

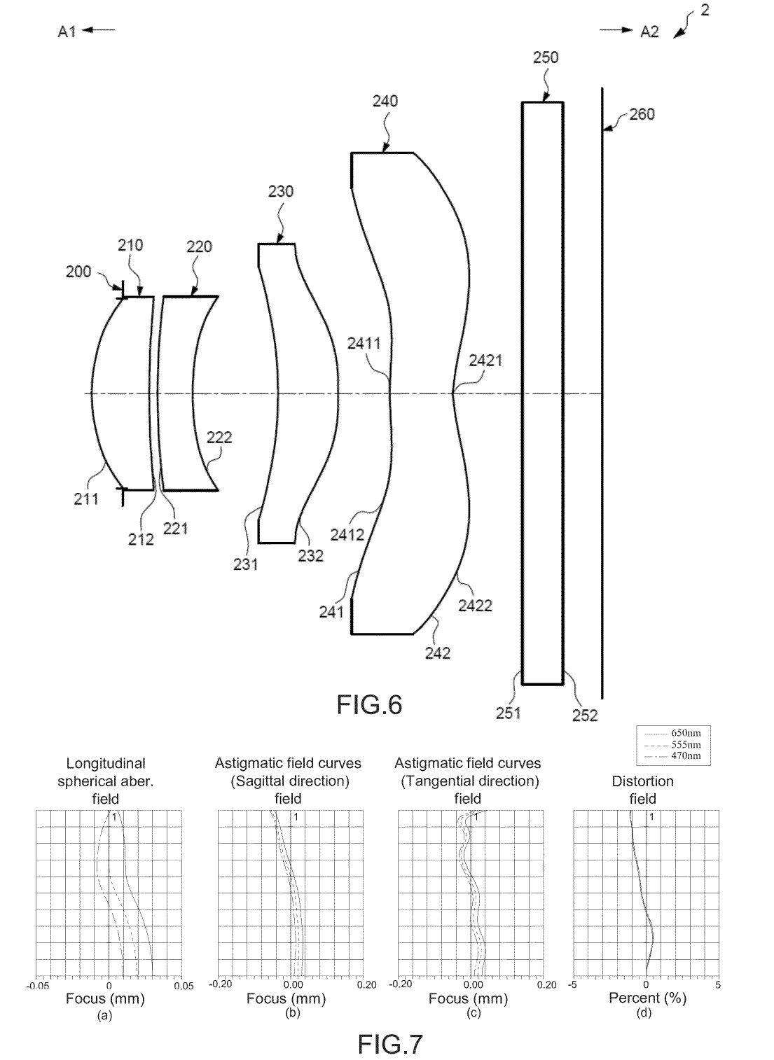

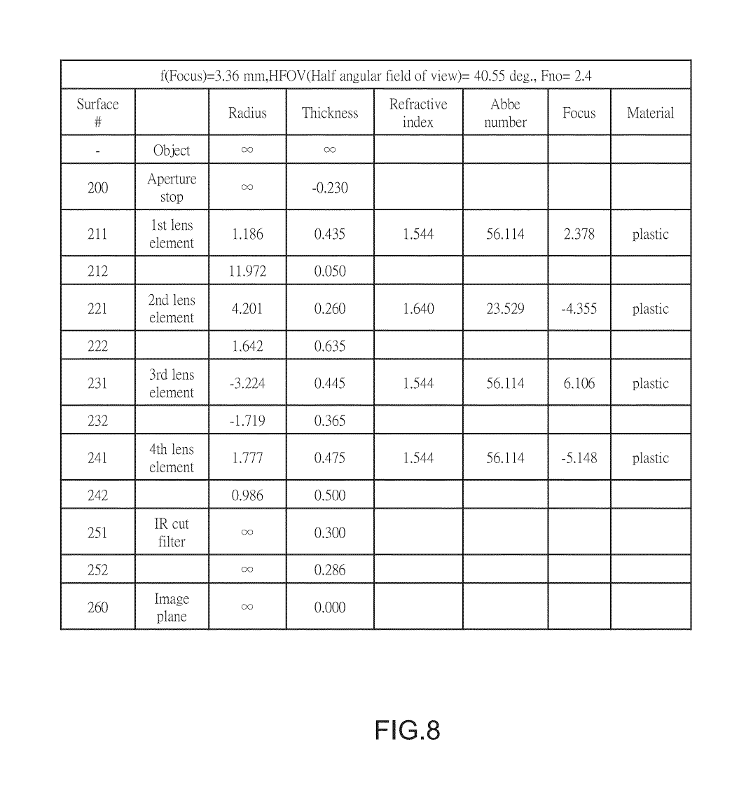

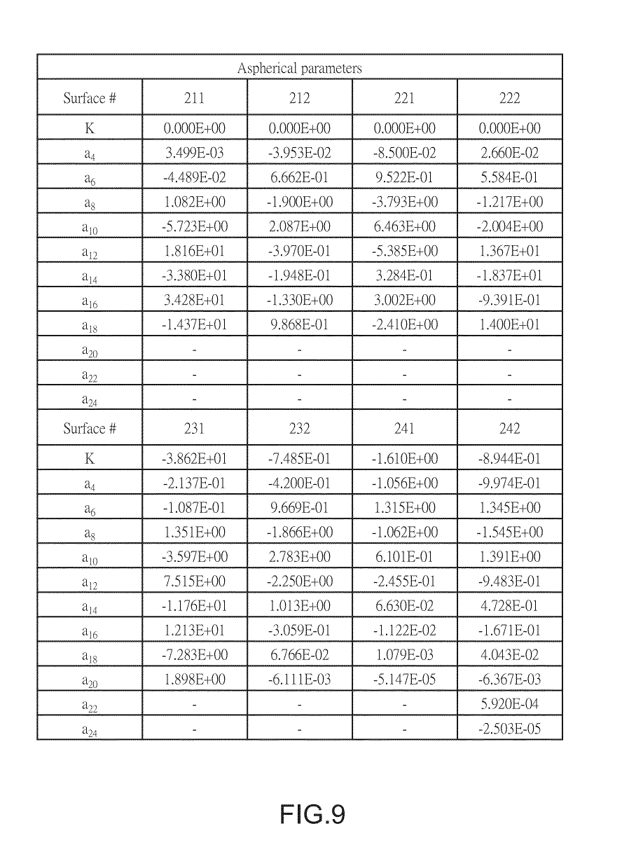

Reference is now made to FIGS. 6-9. FIG. 6 illustrates an example cross-sectional view of an optical imaging lens 2 having four lens elements of the optical imaging lens according to a second example embodiment. FIG. 7 shows example charts of longitudinal spherical aberration and other kinds of optical aberrations of the optical imaging lens 2 according to the second example embodiment. FIG. 8 shows an example table of optical data of each lens element of the optical imaging lens 2 according to the second example embodiment. FIG. 9 shows an example table of aspherical data of the optical imaging lens 2 according to the second example embodiment. The reference numbers labeled in the present embodiment are similar to those in the first embodiment for the similar elements, but here the reference numbers are initialed with 2, for example, reference number 211 for labeling the object-side surface of the first lens element 210, reference number 212 for labeling the image-side surface of the first lens element 210, etc.

As shown in FIG. 6, the optical imaging lens 2 of the present embodiment, in an order from an object side A1 to an image side A2, comprises an aperture stop 200 positioned in front of a first lens element 210, the first lens element 210, a second lens element 220, a third lens element 230, and a fourth lens element 240.

The differences between the second embodiment and the first embodiment are the radius, thickness of each lens element and the distance of each air gap, but the refracting power and configuration of the concave/convex shape of the lens elements (comprising the object-side surfaces 211˜241 facing to the object side A1 and the image-side surfaces 212˜242 facing to the image side A2), surfaces 251, 252 and image plane 260 are similar to those in the first embodiment. Please refer to FIG. 8 for the optical characteristics of each lens elements in the optical imaging lens 2 of the present embodiment, wherein the values of T1/G12, T4/G34, T3/T2, G23/G12, T4/T2, (G23+G34)/G12 and Gaa/T2 are:

T1/G12=8.69, satisfying equation (1);

T4/G34=1.3, satisfying equation (2);

T3/T2=1.71, satisfying equation (3);

G23/G12=12.70, satisfying equation (4);

T4/T2=1.83, satisfying equation (5), (5′);

(G23+G34)/G12=20.01, satisfying equation (6);

Gaa/T2=4.04, satisfying equation (7);

wherein the distance from the object side surface 211 of the first lens element 210 to the image plane 260 on the optical axis is 3.75 (mm) and the length of the optical imaging lens 2 is shortened.

As shown in FIG. 7, the optical imaging lens 2 of the present embodiment shows great characteristics in longitudinal spherical aberration (a), astigmatism in the sagittal direction (b), astigmatism in the tangential direction (c), and distortion aberration (d). Therefore, according to the above illustration, the optical imaging lens of the present embodiment indeed shows great optical performance and the length of the optical imaging lens 2 is effectively shortened.

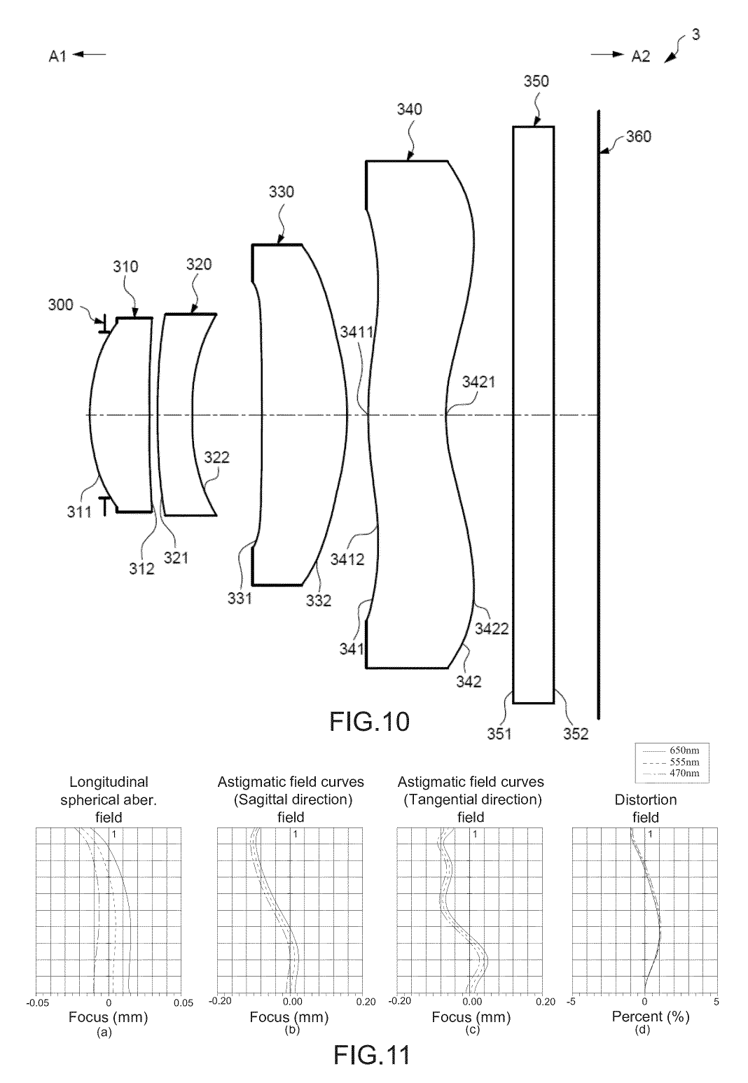

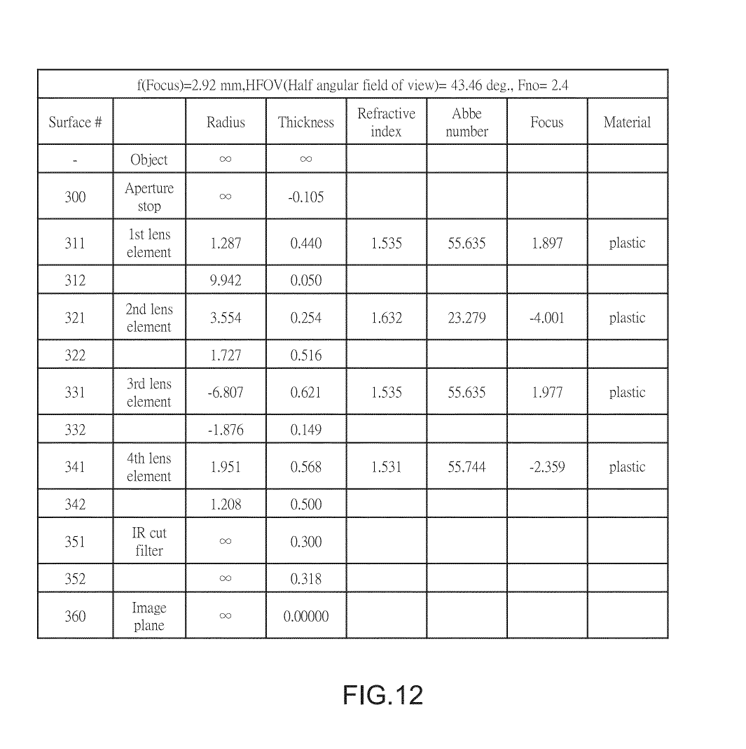

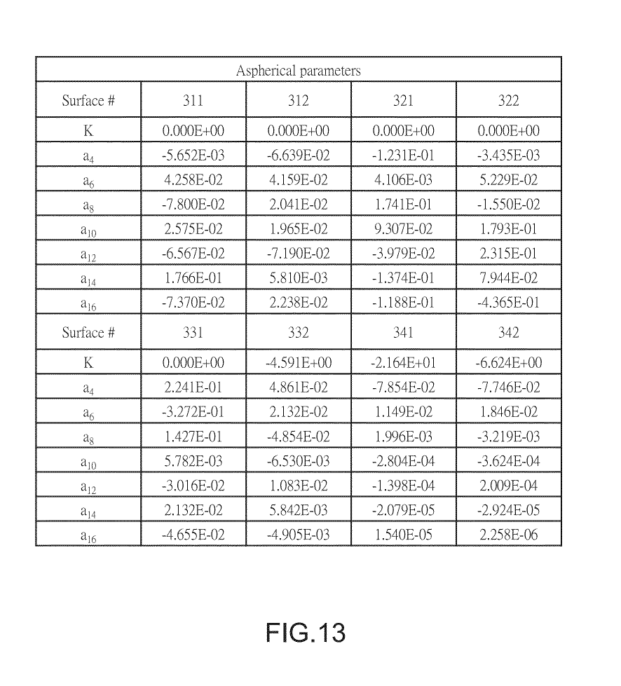

Reference is now made to FIGS. 10-13. FIG. 10 illustrates an example cross-sectional view of an optical imaging lens 3 having four lens elements of the optical imaging lens according to a third example embodiment. FIG. 11 shows example charts of longitudinal spherical aberration and other kinds of optical aberrations of the optical imaging lens 3 according to the third example embodiment. FIG. 12 shows an example table of optical data of each lens element of the optical imaging lens 3 according to the third example embodiment. FIG. 13 shows an example table of aspherical data of the optical imaging lens 3 according to the third example embodiment. The reference numbers labeled in the present embodiment are similar to those in the first embodiment for the similar elements, but here the reference numbers are initialed with 3, for example, reference number 311 for labeling the object-side surface of the first lens element 310, reference number 312 for labeling the image-side surface of the first lens element 310, etc.

As shown in FIG. 10, the optical imaging lens 3 of the present embodiment, in an order from an object side A1 to an image side A2, comprises an aperture stop 300 positioned in front of a first lens element 310, the first lens element 310, a second lens element 320, a third lens element 330, and a fourth lens element 340.

The differences between the third embodiment and the first embodiment are the radius, thickness of each lens element and the distance of each air gap, but the refracting power and configuration of the concave/convex shape of the lens elements (comprising the object-side surfaces 311˜341 facing to the object side A1 and the image-side surfaces 312˜342 facing to the image side A2), surfaces 351, 352 and image plane 360 are similar to those in the first embodiment. Please refer to FIG. 12 for the optical characteristics of each lens elements in the optical imaging lens 3 of the present embodiment, wherein the values of T1/G12, T4/G34, T3/T2, G23/G12, T4/T2, (G23+G34)/G12 and Gaa/T2 are:

T1/G12=8.80, satisfying equation (1);

T4/G34=3.80, satisfying equation (2);

T3/T2=2.44, satisfying equation (3);

G23/G12=10.33, satisfying equation (4);

T4/T2=2.23, satisfying equation (5), (5′);

(G23+G34)/G12=13.32, satisfying equation (6);

Gaa/T2=2.81;

wherein the distance from the object side surface 311 of the first lens element 310 to the image plane 360 on the optical axis is 3.72 (mm) and the length of the optical imaging lens 3 is shortened.

As shown in FIG. 11, the optical imaging lens 3 of the present embodiment shows great characteristics in longitudinal spherical aberration (a), astigmatism in the sagittal direction (b), astigmatism in the tangential direction (c), and distortion aberration (d). Therefore, according to the above illustration, the optical imaging lens of the present embodiment indeed shows great optical performance and the length of the optical imaging lens 3 is effectively shortened.

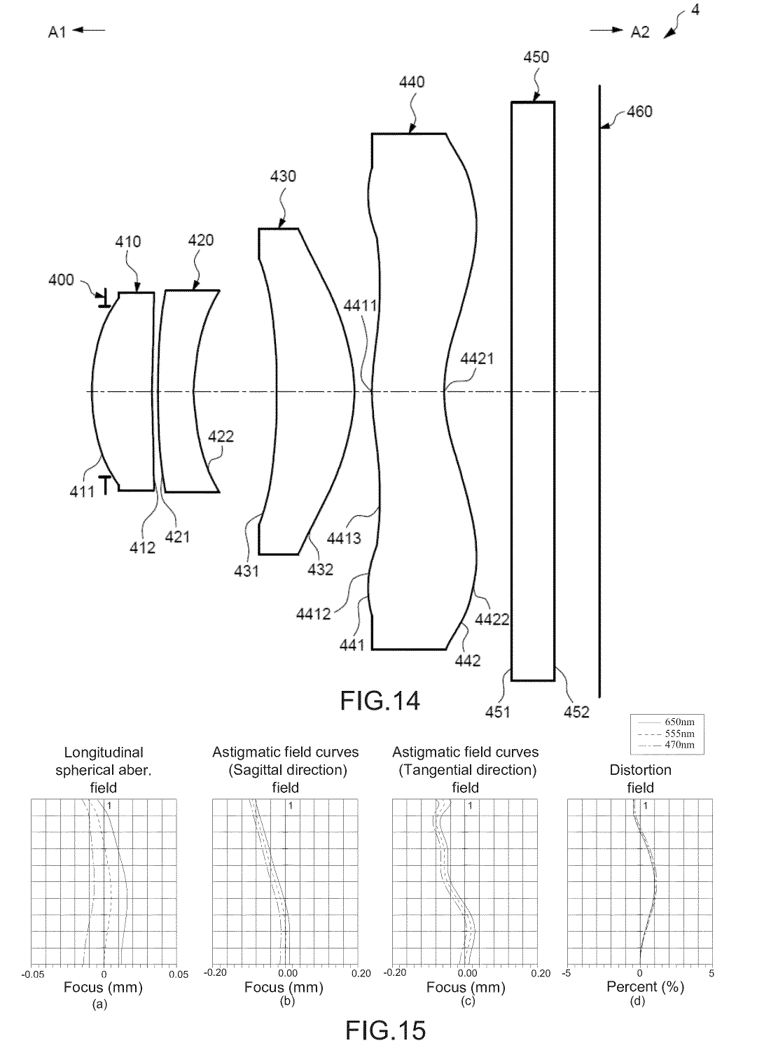

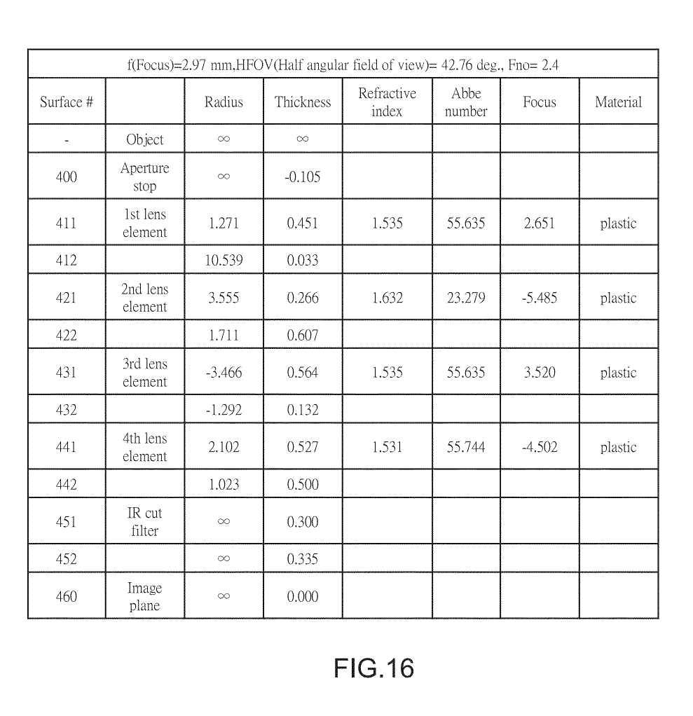

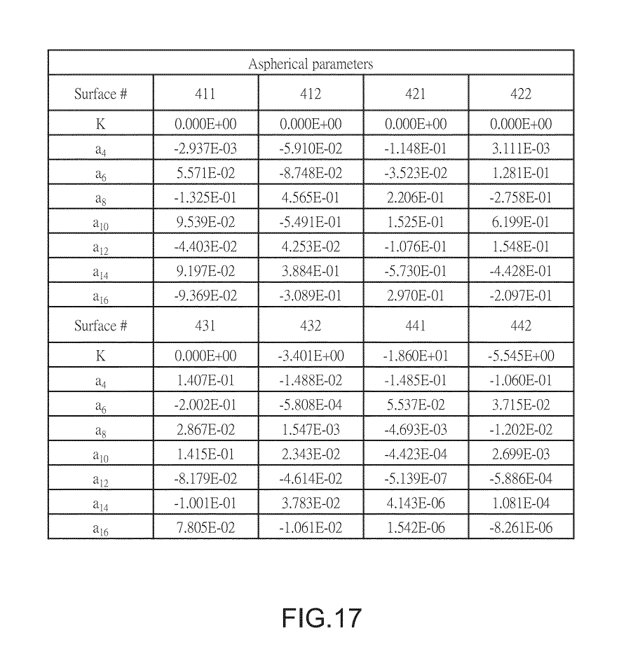

Reference is now made to FIGS. 14-17. FIG. 14 illustrates an example cross-sectional view of an optical imaging lens 4 having four lens elements of the optical imaging lens according to a fourth example embodiment. FIG. 15 shows example charts of longitudinal spherical aberration and other kinds of optical aberrations of the optical imaging lens 4 according to the fourth example embodiment. FIG. 16 shows an example table of optical data of each lens element of the optical imaging lens 4 according to the fourth example embodiment. FIG. 17 shows an example table of aspherical data of the optical imaging lens 4 according to the fourth example embodiment. The reference numbers labeled in the present embodiment are similar to those in the first embodiment for the similar elements, but here the reference numbers are initialed with 4, for example, reference number 411 for labeling the object-side surface of the first lens element 410, reference number 412 for labeling the image-side surface of the first lens element 410, etc.

As shown in FIG. 14, the optical imaging lens 4 of the present embodiment, in an order from an object side A1 to an image side A2, comprises an aperture stop 400 positioned in front of a first lens element 410, the first lens element 410, a second lens element 420, a third lens element 430, and a fourth lens element 440.

The differences between the fourth embodiment and the first embodiment are the radius, thickness of each lens element, the distance of each air gap, and configuration of some concave/convex shapes of some lens elements (comprising a convex portion 4412 in a vicinity of a periphery of the fourth lens element 440 and a concave portion 4413 in a vicinity between the optical axis and a periphery of the fourth lens element 440 on the object-side surface 441 thereof), but the refracting power and configuration of other concave/convex shape of the lens elements (comprising the object-side surfaces 411˜431 facing to the object side A1 and the image-side surfaces 412˜442 facing to the image side A2), surfaces 451, 452 and image plane 460 are similar to those in the first embodiment. Please refer to FIG. 16 for the optical characteristics of each lens elements in the optical imaging lens 4 of the present embodiment, wherein the values of T1/G12, T4/G34, T3/T2, G23/G12, T4/T2, (G23+G34)/G12 and Gaa/T2 are:

T1/G12=13.58, satisfying equation (1);

T4/G34=3.99, satisfying equation (2);

T3/T2=2.12, satisfying equation (3);

G23/G12=18.23, satisfying equation (4);

T4/T2=1.98, satisfying equation (5), (5′);

(G23+G34)/G12=22.20, satisfying equation (6);

Gaa/T2=2.90;

wherein the distance from the object side surface 411 of the first lens element 410 to the image plane 460 on the optical axis is 3.72 (mm) and the length of the optical imaging lens 4 is shortened.

As shown in FIG. 15, the optical imaging lens 4 of the present embodiment shows great characteristics in longitudinal spherical aberration (a), astigmatism in the sagittal direction (b), astigmatism in the tangential direction (c), and distortion aberration (d). Therefore, according to the above illustration, the optical imaging lens of the present embodiment indeed shows great optical performance and the length of the optical imaging lens 4 is effectively shortened.

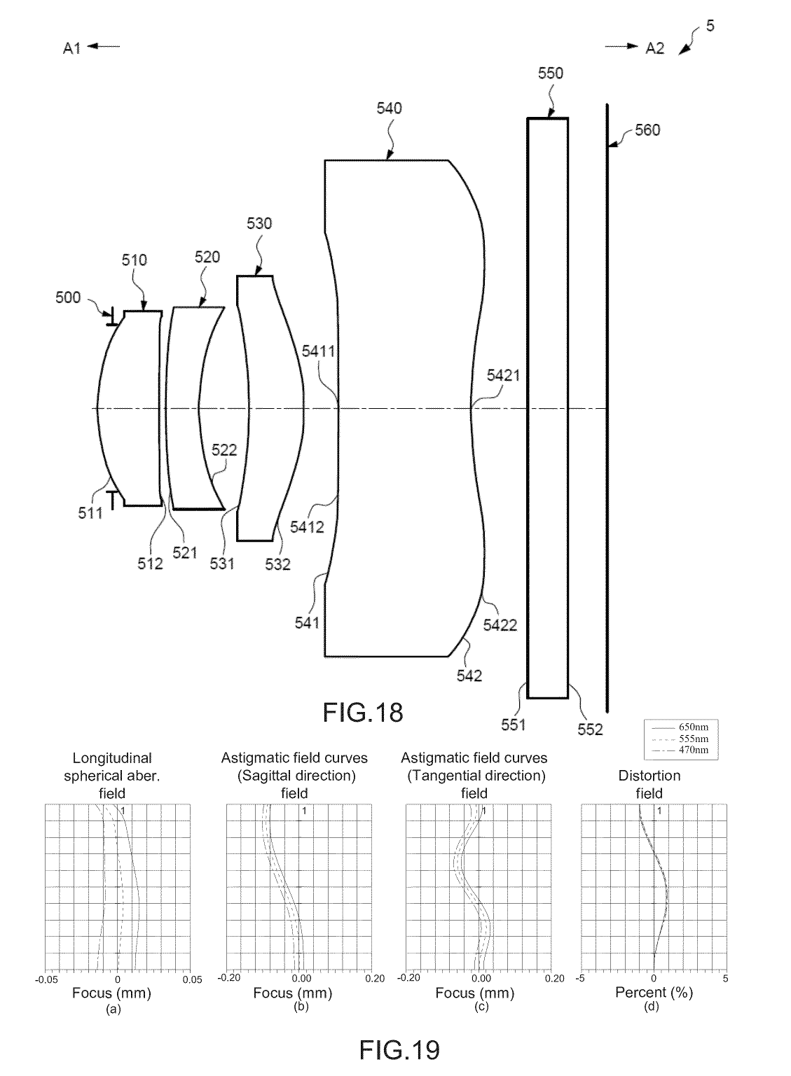

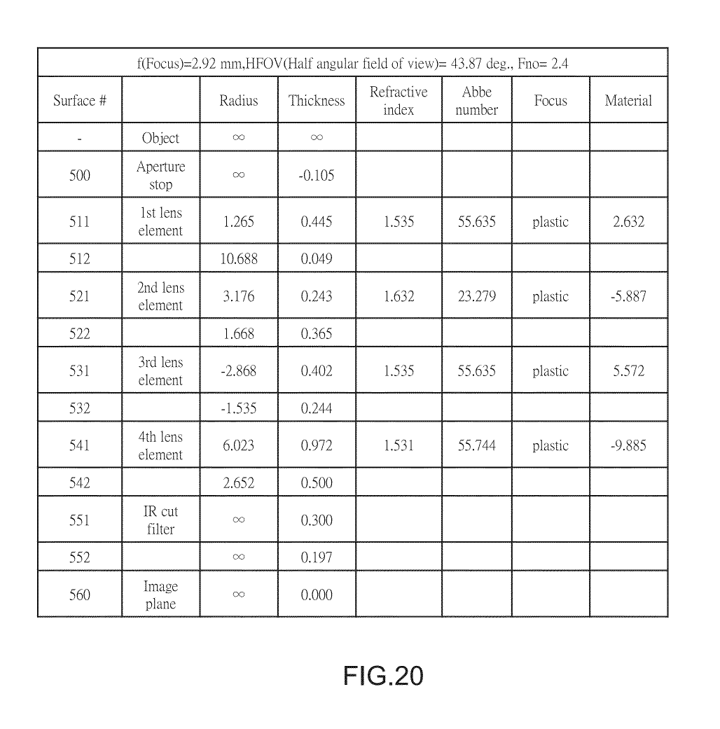

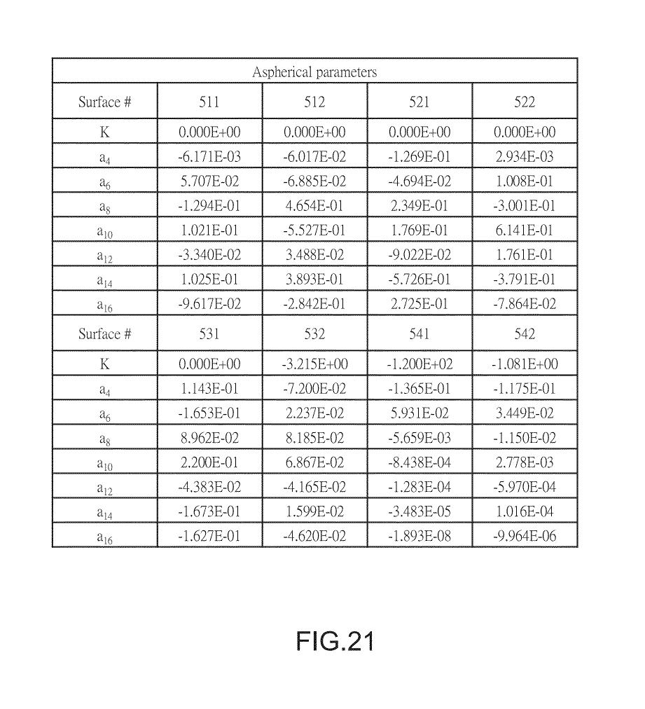

Reference is now made to FIGS. 18-21. FIG. 18 illustrates an example cross-sectional view of an optical imaging lens 5 having four lens elements of the optical imaging lens according to a fifth example embodiment. FIG. 19 shows example charts of longitudinal spherical aberration and other kinds of optical aberrations of the optical imaging lens 5 according to the fifth example embodiment. FIG. 20 shows an example table of optical data of each lens element of the optical imaging lens 5 according to the fifth example embodiment. FIG. 21 shows an example table of aspherical data of the optical imaging lens 5 according to the fifth example embodiment. The reference numbers labeled in the present embodiment are similar to those in the first embodiment for the similar elements, but here the reference numbers are initialed with 5, for example, reference number 511 for labeling the object-side surface of the first lens element 510, reference number 512 for labeling the image-side surface of the first lens element 510, etc.

As shown in FIG. 18, the optical imaging lens 5 of the present embodiment, in an order from an object side A1 to an image side A2, comprises an aperture stop 500 positioned in front of a first lens element 510, the first lens element 510, a second lens element 520, a third lens element 530, and a fourth lens element 540.

The differences between the fifth embodiment and the first embodiment are the radius, thickness of each lens element and the distance of each air gap, but the refracting power and configuration of the concave/convex shape of the lens elements (comprising the object-side surfaces 511˜541 facing to the object side A1 and the image-side surfaces 512˜542 facing to the image side A2), surfaces 551, 552 and image plane 560 are similar to those in the first embodiment. Please refer to FIG. 20 for the optical characteristics of each lens elements in the optical imaging lens 5 of the present embodiment, wherein the values of T1/G12, T4/G34, T3/T2, G23/G12, T4/T2, (G23+G34)/G12 and Gaa/T2 are:

T1/G12=9.15, satisfying equation (1);

T4/G34=3.99, satisfying equation (2);

T3/T2=1.65, satisfying equation (3);

G23/G12=7.50, satisfying equation (4);

T4/T2=4.00, satisfying equation (5), (5′);

(G23+G34)/G12=12.51, satisfying equation (6);

Gaa/T2=2.70;

wherein the distance from the object side surface 511 of the first lens element 510 to the image plane 560 on the optical axis is 3.72 (mm) and the length of the optical imaging lens 5 is shortened.

As shown in FIG. 19, the optical imaging lens 5 of the present embodiment shows great characteristics in longitudinal spherical aberration (a), astigmatism in the sagittal direction (b), astigmatism in the tangential direction (c), and distortion aberration (d). Therefore, according to the above illustration, the optical imaging lens of the present embodiment indeed shows great optical performance and the length of the optical imaging lens 5 is effectively shortened.

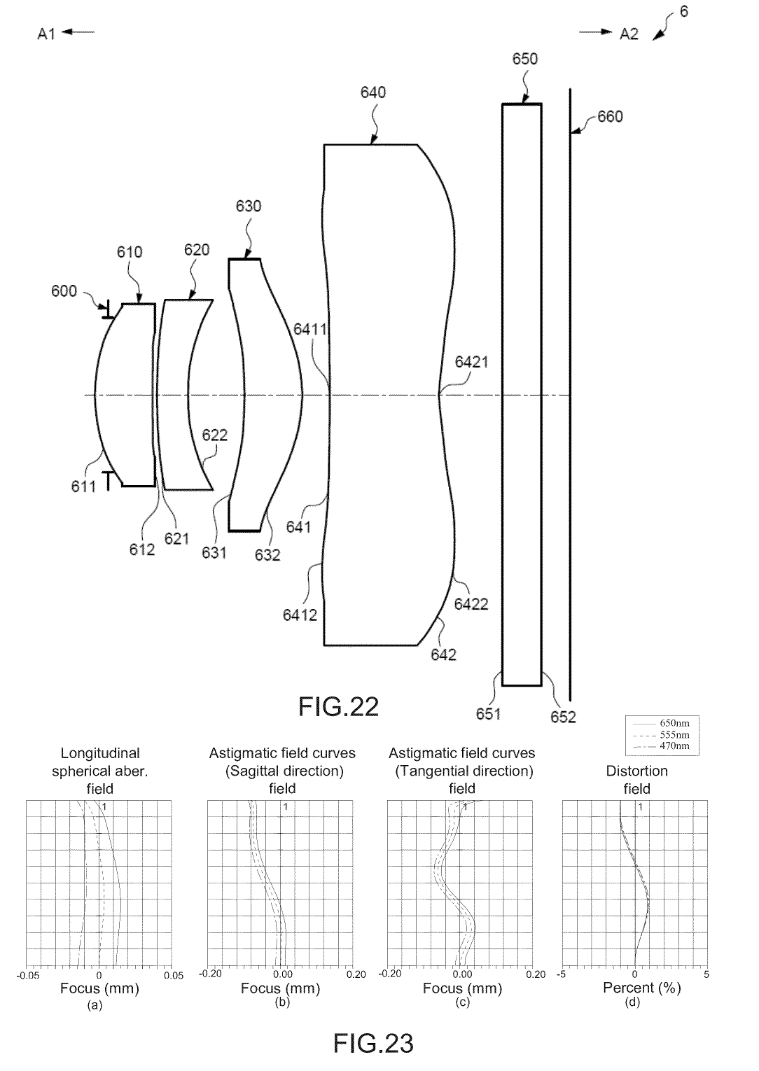

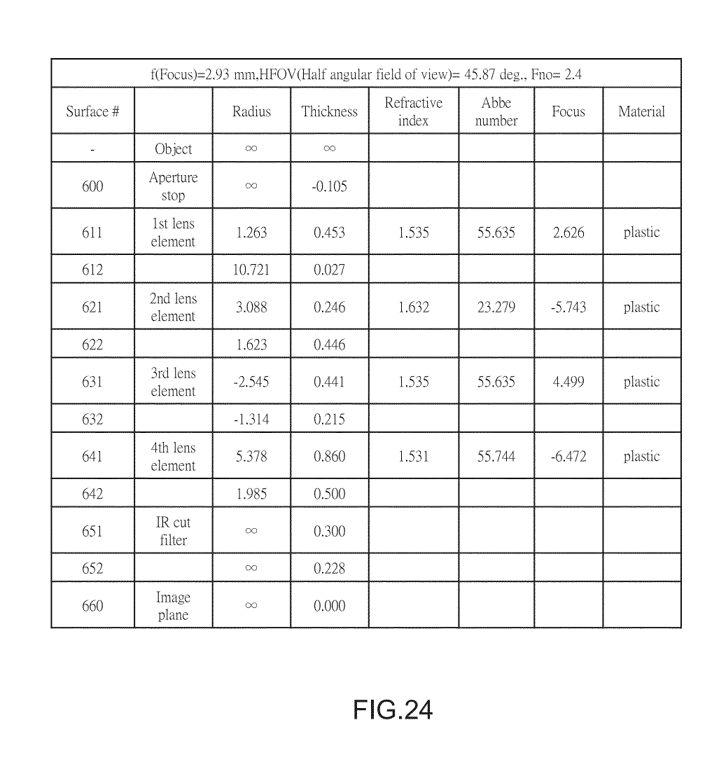

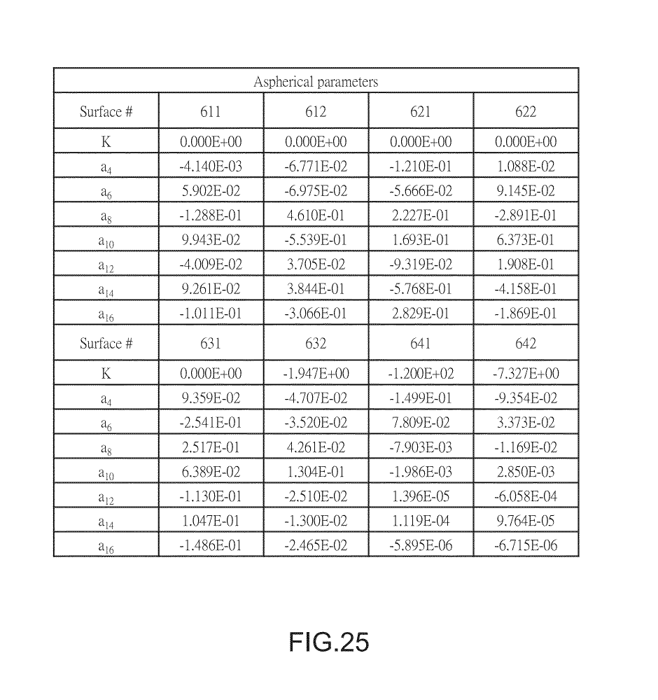

Reference is now made to FIGS. 22-25. FIG. 22 illustrates an example cross-sectional view of an optical imaging lens 6 having four lens elements of the optical imaging lens according to a sixth example embodiment. FIG. 23 shows example charts of longitudinal spherical aberration and other kinds of optical aberrations of the optical imaging lens 6 according to the sixth example embodiment. FIG. 24 shows an example table of optical data of each lens element of the optical imaging lens 6 according to the sixth example embodiment. FIG. 25 shows an example table of aspherical data of the optical imaging lens 6 according to the sixth example embodiment. The reference numbers labeled in the present embodiment are similar to those in the first embodiment for the similar elements, but here the reference numbers are initialed with 6, for example, reference number 611 for labeling the object-side surface of the first lens element 610, reference number 612 for labeling the image-side surface of the first lens element 610, etc.

As shown in FIG. 22, the optical imaging lens 6 of the present embodiment, in an order from an object side A1 to an image side A2, comprises an aperture stop 600 positioned in front of a first lens element 610, the first lens element 610, a second lens element 620, a third lens element 630, and a fourth lens element 640.

The differences between the sixth embodiment and the first embodiment are the radius, thickness of each lens element, the distance of each air gap and configuration of some concave/convex shapes of some lens elements (comprising a convex portion 6412 in a vicinity of a periphery of the fourth lens element 640 on the object-side surface 641 thereof), but the refracting power and configuration of other concave/convex shape of the lens elements (comprising the object-side surfaces 611˜631 facing to the object side A1 and the image-side surfaces 612˜642 facing to the image side A2), surfaces 651, 652 and image plane 660 are similar to those in the first embodiment. Please refer to FIG. 24 for the optical characteristics of each lens elements in the optical imaging lens 6 of the present embodiment, wherein the values of T1/G12, T4/G34, T3/T2, G23/G12, T4/T2, (G23+G34)/G12 and Gaa/T2 are:

T1/G12=16.58, satisfying equation (1);

T4/G34=3.99, satisfying equation (2);

T3/T2=1.80, satisfying equation (3);

G23/G12=16.34, satisfying equation (4);

T4/T2=3.50, satisfying equation (5), (5′);

(G23+G34)/G12=24.23, satisfying equation (6);

Gaa/T2=2.80;

wherein the distance from the object side surface 611 of the first lens element 610 to the image plane 660 on the optical axis is 3.72 (mm) and the length of the optical imaging lens 6 is shortened.

As shown in FIG. 23, the optical imaging lens 6 of the present embodiment shows great characteristics in longitudinal spherical aberration (a), astigmatism in the sagittal direction (b), astigmatism in the tangential direction (c), and distortion aberration (d). Therefore, according to the above illustration, the optical imaging lens of the present embodiment indeed shows great optical performance and the length of the optical imaging lens 6 is effectively shortened.

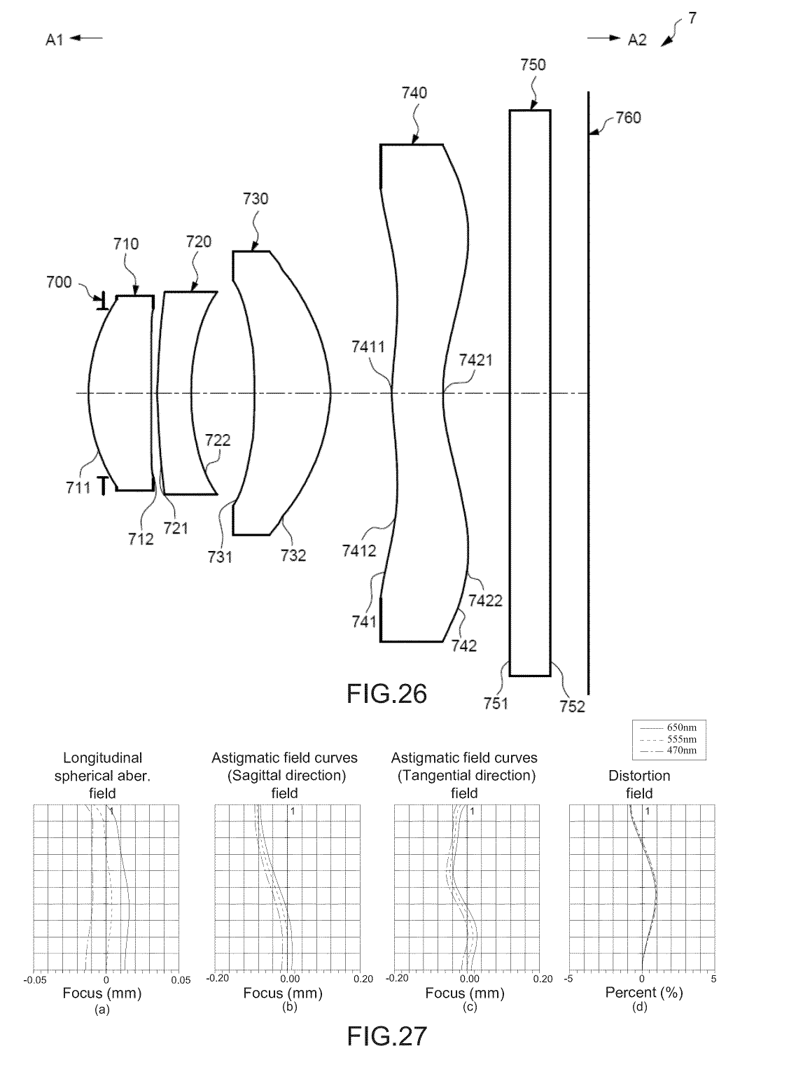

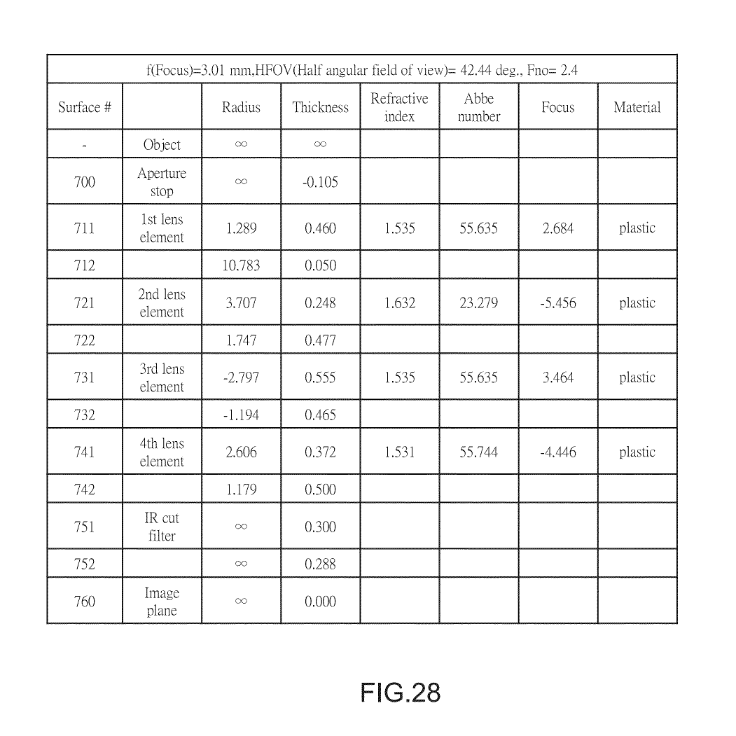

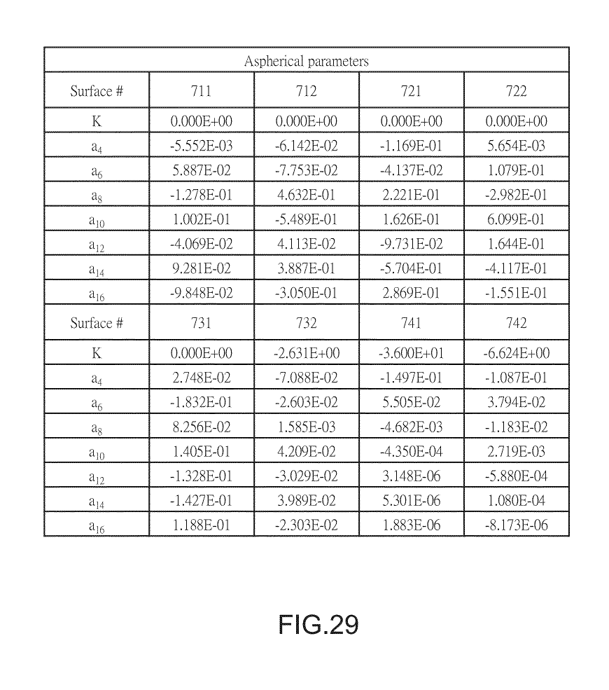

Reference is now made to FIGS. 26-29. FIG. 26 illustrates an example cross-sectional view of an optical imaging lens 7 having four lens elements of the optical imaging lens according to a seventh example embodiment. FIG. 27 shows example charts of longitudinal spherical aberration and other kinds of optical aberrations of the optical imaging lens 7 according to the seventh example embodiment. FIG. 28 shows an example table of optical data of each lens element of the optical imaging lens 7 according to the seventh example embodiment. FIG. 29 shows an example table of aspherical data of the optical imaging lens 7 according to the seventh example embodiment. The reference numbers labeled in the present embodiment are similar to those in the first embodiment for the similar elements, but here the reference numbers are initialed with 7, for example, reference number 711 for labeling the object-side surface of the first lens element 710, reference number 712 for labeling the image-side surface of the first lens element 710, etc.

As shown in FIG. 26, the optical imaging lens 7 of the present embodiment, in an order from an object side A1 to an image side A2, comprises an aperture stop 700 positioned in front of a first lens element 710, the first lens element 710, a second lens element 720, a third lens element 730, and a fourth lens element 740.

The differences between the seventh embodiment and the first embodiment are the radius, thickness of each lens element and the distance of each air gap, but the refracting power and configuration of the concave/convex shape of the lens elements (comprising the object-side surfaces 711˜741 facing to the object side A1 and the image-side surfaces 712˜742 facing to the image side A2), surfaces 751, 752 and image plane 760 are similar to those in the first embodiment. Please refer to FIG. 28 for the optical characteristics of each lens elements in the optical imaging lens 7 of the present embodiment, wherein the values of T1/G12, T4/G34, T3/T2, G23/G12, T4/T2, (G23+G34)/G12 and Gaa/T2 are:

T1/G12=9.25, satisfying equation (1);

T4/G34=0.80, satisfying equation (2);

T3/T2=2.23, satisfying equation (3);

G23/G12=9.60, satisfying equation (4);

T4/T2=1.50, satisfying equation (5);

(G23+G34)/G12=18.96, satisfying equation (6);

Gaa/T2=3.99, satisfying equation (7);

wherein the distance from the object side surface 711 of the first lens element 710 to the image plane 760 on the optical axis is 3.72 (mm) and the length of the optical imaging lens 7 is shortened.

As shown in FIG. 27, the optical imaging lens 7 of the present embodiment shows great characteristics in longitudinal spherical aberration (a), astigmatism in the sagittal direction (b), astigmatism in the tangential direction (c), and distortion aberration (d). Therefore, according to the above illustration, the optical imaging lens of the present embodiment indeed shows great optical performance and the length of the optical imaging lens 7 is effectively shortened.

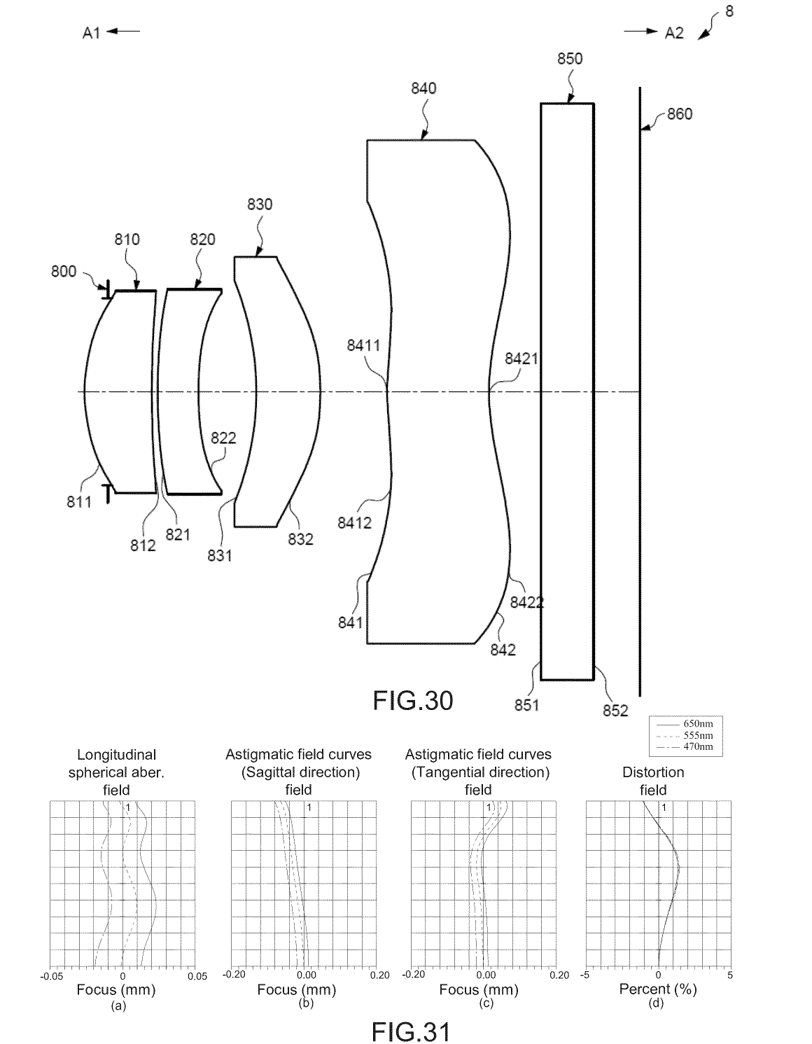

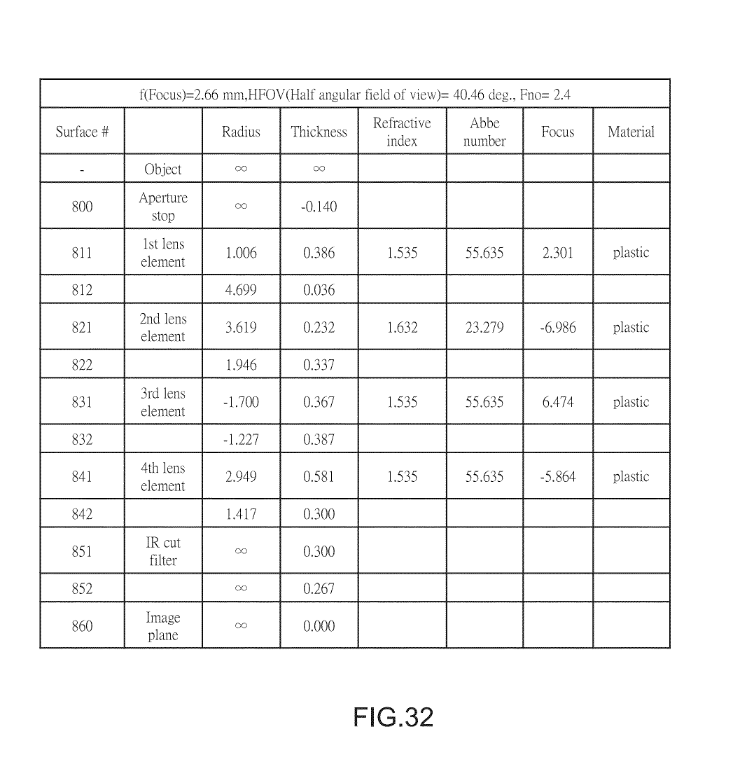

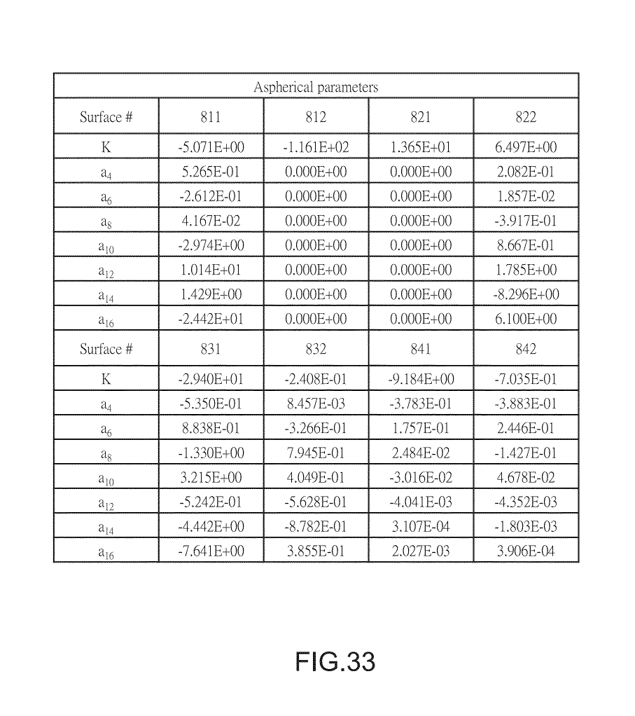

Reference is now made to FIGS. 30-33. FIG. 30 illustrates an example cross-sectional view of an optical imaging lens 8 having four lens elements of the optical imaging lens according to a eighth example embodiment. FIG. 31 shows example charts of longitudinal spherical aberration and other kinds of optical aberrations of the optical imaging lens 8 according to the eighth example embodiment. FIG. 32 shows an example table of optical data of each lens element of the optical imaging lens 8 according to the eighth example embodiment. FIG. 33 shows an example table of aspherical data of the optical imaging lens 8 according to the eighth example embodiment. The reference numbers labeled in the present embodiment are similar to those in the first embodiment for the similar elements, but here the reference numbers are initialed with 8, for example, reference number 811 for labeling the object-side surface of the first lens element 810, reference number 812 for labeling the image-side surface of the first lens element 810, etc.

As shown in FIG. 30, the optical imaging lens 8 of the present embodiment, in an order from an object side A1 to an image side A2, comprises an aperture stop 800 positioned in front of a first lens element 810, the first lens element 810, a second lens element 820, a third lens element 830, and a fourth lens element 840.

The differences between the eighth embodiment and the first embodiment are the radius, thickness of each lens element, the distance of each air gap and zero values for the a4˜a16 of the image-side surface 812 of the first lens element 810 and the object-side surface 821 of the second lens element 820, but the refracting power and configuration of the concave/convex shape of the lens elements (comprising the object-side surfaces 811˜841 facing to the object side A1 and the image-side surfaces 812˜842 facing to the image side A2), surfaces 851, 852 and image plane 860 are similar to those in the first embodiment. Please refer to FIG. 32 for the optical characteristics of each lens elements in the optical imaging lens 8 of the present embodiment, wherein the values of T1/G12, T4/G34, T3/T2, G23/G12, T4/T2, (G23+G34)/G12 and Gaa/T2 are:

T1/G12=10.80, satisfying equation (1);

T4/G34=1.50, satisfying equation (2);

T3/T2=1.58, satisfying equation (3);

G23/G12=9.42, satisfying equation (4);

T4/T2=2.50, satisfying equation (5), (5′);

(G23+G34)/G12=20.25, satisfying equation (6);

Gaa/T2=3.27, satisfying equation (7);

wherein the distance from the object side surface 811 of the first lens element 810 to the image plane 860 on the optical axis is 3.19 (mm) and the length of the optical imaging lens 8 is shortened.

As shown in FIG. 31, the optical imaging lens 8 of the present embodiment shows great characteristics in longitudinal spherical aberration (a), astigmatism in the sagittal direction (b), astigmatism in the tangential direction (c), and distortion aberration (d). Therefore, according to the above illustration, the optical imaging lens of the present embodiment indeed shows great optical performance and the length of the optical imaging lens 8 is effectively shortened.

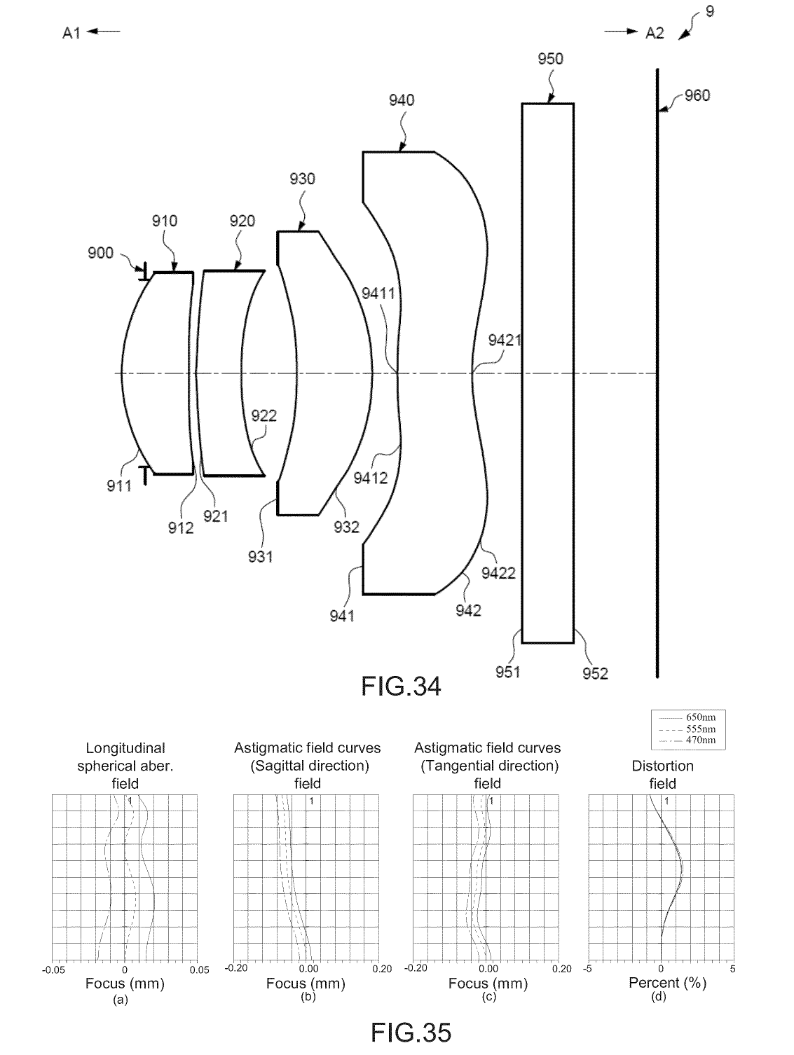

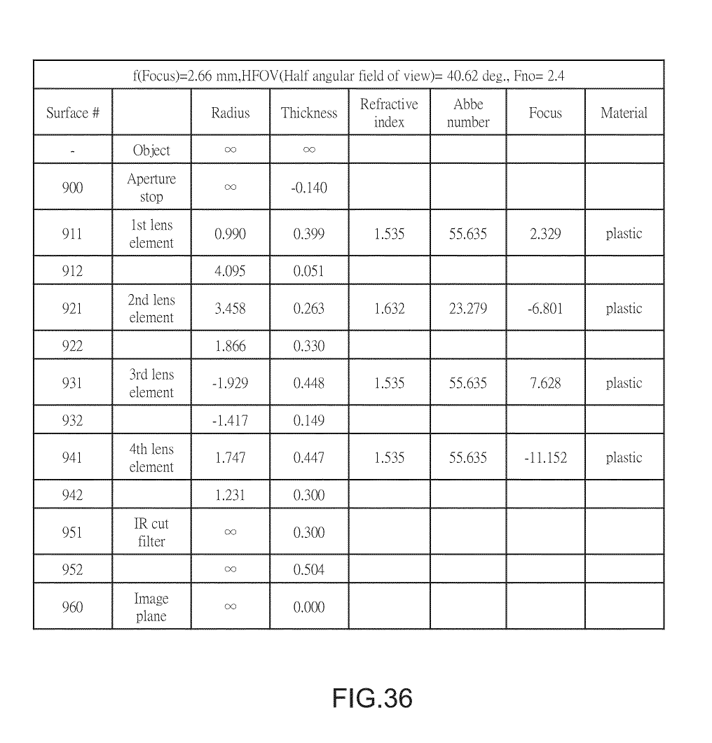

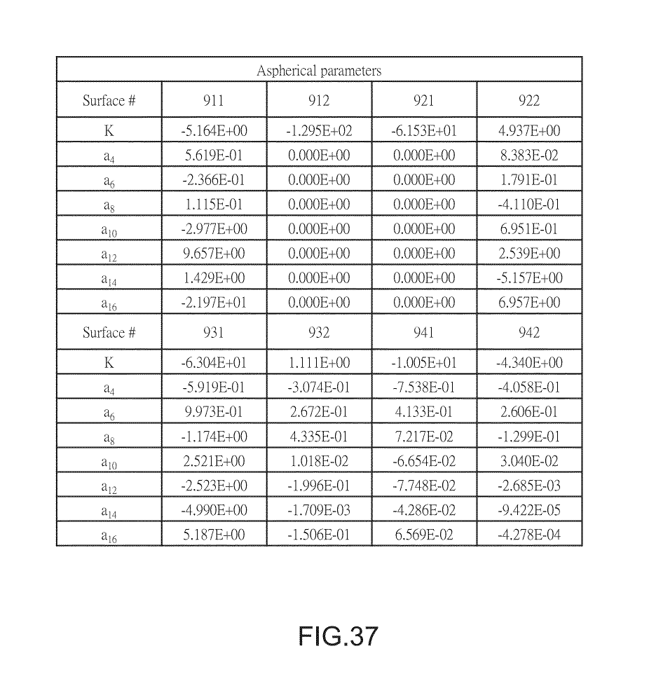

Reference is now made to FIGS. 34-37. FIG. 34 illustrates an example cross-sectional view of an optical imaging lens 9 having four lens elements of the optical imaging lens according to a ninth example embodiment. FIG. 35 shows example charts of longitudinal spherical aberration and other kinds of optical aberrations of the optical imaging lens 9 according to the ninth example embodiment. FIG. 36 shows an example table of optical data of each lens element of the optical imaging lens 9 according to the ninth example embodiment. FIG. 37 shows an example table of aspherical data of the optical imaging lens 9 according to the ninth example embodiment. The reference numbers labeled in the present embodiment are similar to those in the first embodiment for the similar elements, but here the reference numbers are initialed with 9, for example, reference number 911 for labeling the object-side surface of the first lens element 910, reference number 912 for labeling the image-side surface of the first lens element 910, etc.

As shown in FIG. 34, the optical imaging lens 9 of the present embodiment, in an order from an object side A1 to an image side A2, comprises an aperture stop 900 positioned in front of a first lens element 910, the first lens element 910, a second lens element 920, a third lens element 930, and a fourth lens element 940.

The differences between the ninth embodiment and the first embodiment are the radius, thickness of each lens element, the distance of each air gap and zero values for the a4˜a16 of the image-side surface 912 of the first lens element 910 and the object-side surface 921 of the second lens element 920, but the refracting power and configuration of the concave/convex shape of the lens elements (comprising the object-side surfaces 911˜941 facing to the object side A1 and the image-side surfaces 912˜942 facing to the image side A2), surfaces 951, 952 and image plane 960 are similar to those in the first embodiment. Please refer to FIG. 36 for the optical characteristics of each lens elements in the optical imaging lens 9 of the present embodiment, wherein the values of T1/G12, T4/G34, T3/T2, G23/G12, T4/T2, (G23+G34)/G12 and Gaa/T2 are:

T1/G12=7.89, satisfying equation (1);

T4/G34=3.00, satisfying equation (2);

T3/T2=1.71, satisfying equation (3);

G23/G12=6.54, satisfying equation (4);

T4/T2=1.70, satisfying equation (5);

(G23+G34)/G12=9.49, satisfying equation (6);

Gaa/T2=2.02;

wherein the distance from the object side surface 911 of the first lens element 910 to the image plane 960 on the optical axis is 3.19 (mm) and the length of the optical imaging lens 9 is shortened.

As shown in FIG. 35, the optical imaging lens 9 of the present embodiment shows great characteristics in longitudinal spherical aberration (a), astigmatism in the sagittal direction (b), astigmatism in the tangential direction (c), and distortion aberration (d). Therefore, according to the above illustration, the optical imaging lens of the present embodiment indeed shows great optical performance and the length of the optical imaging lens 9 is effectively shortened.

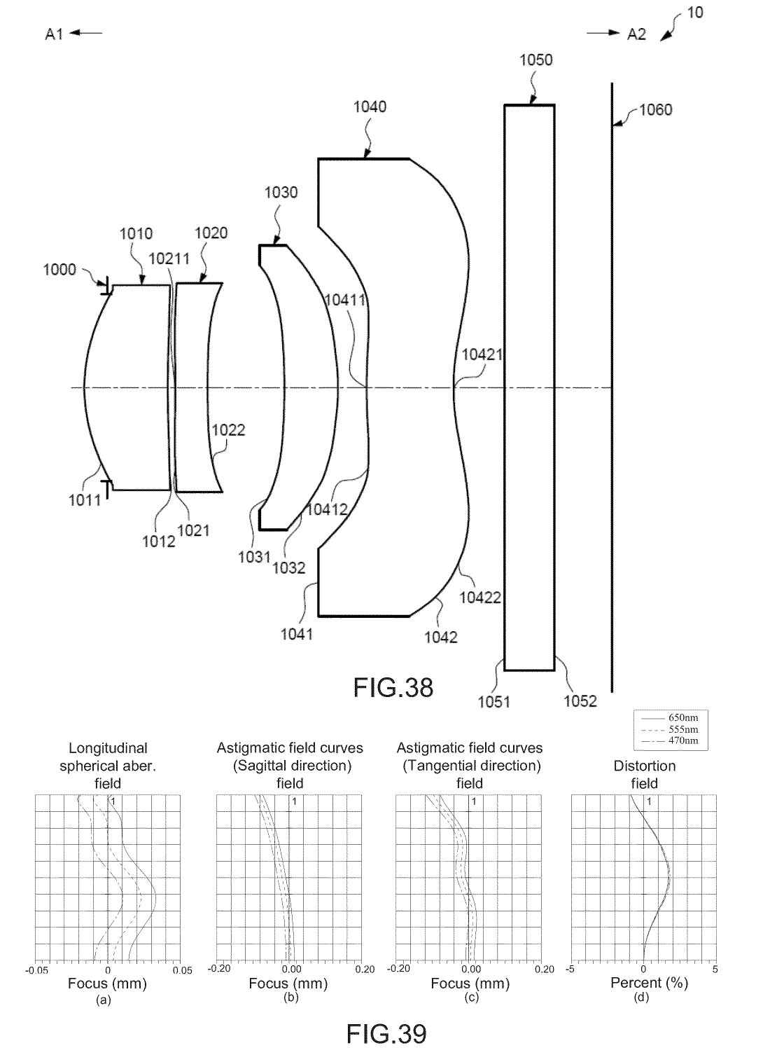

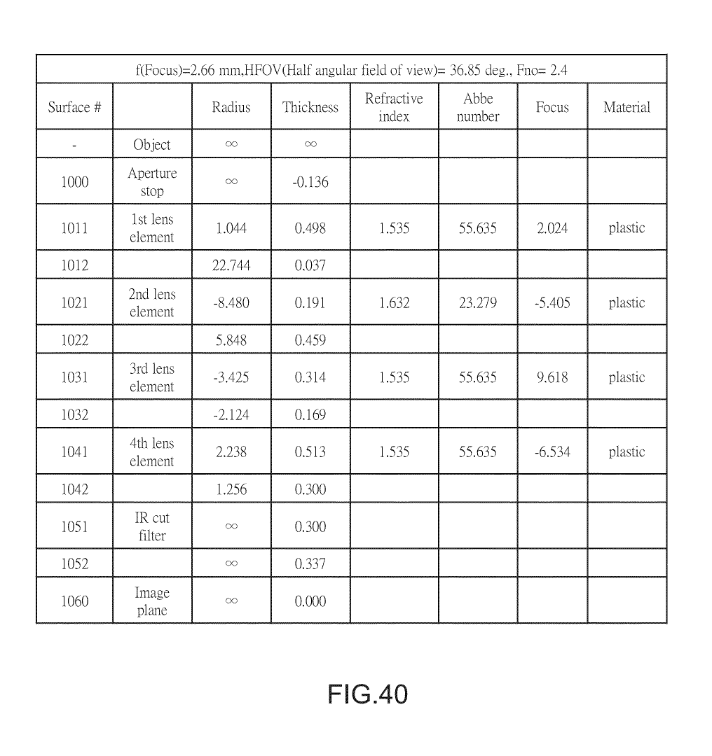

Reference is now made to FIGS. 38-41. FIG. 38 illustrates an example cross-sectional view of an optical imaging lens 10 having four lens elements of the optical imaging lens according to a tenth example embodiment. FIG. 39 shows example charts of longitudinal spherical aberration and other kinds of optical aberrations of the optical imaging lens 10 according to the tenth example embodiment. FIG. 40 shows an example table of optical data of each lens element of the optical imaging lens 10 according to the tenth example embodiment.

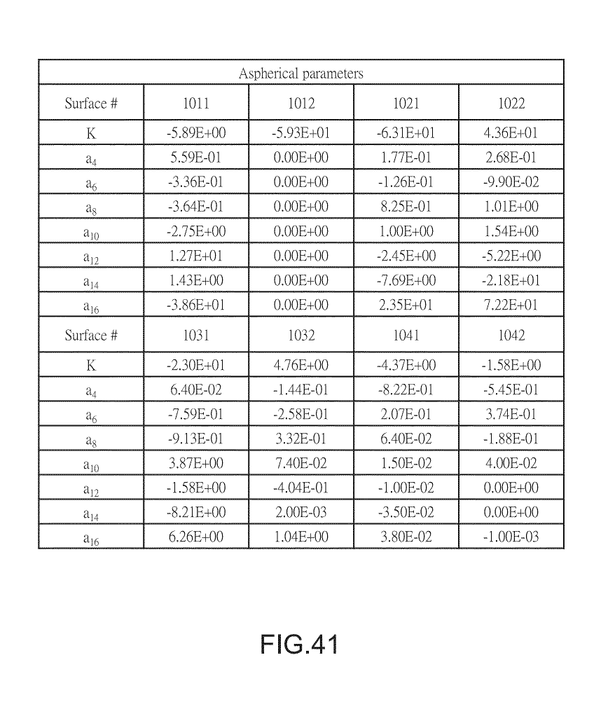

FIG. 41 shows an example table of aspherical data of the optical imaging lens 10 according to the tenth example embodiment. The reference numbers labeled in the present embodiment are similar to those in the first embodiment for the similar elements, but here the reference numbers are initialed with 10, for example, reference number 1011 for labeling the object-side surface of the first lens element 1010, reference number 1012 for labeling the image-side surface of the first lens element 1010, etc.

As shown in FIG. 38, the optical imaging lens 10 of the present embodiment, in an order from an object side A1 to an image side A2, comprises an aperture stop 1000 positioned in front of a first lens element 1010, the first lens element 1010, a second lens element 1020, a third lens element 1030, and a fourth lens element 1040.

The differences between the tenth embodiment and the first embodiment are the radius, thickness of each lens element, the distance of each air gap, configuration of some concave/convex shape of some lens element (comprising a concave portion 10211 in a vicinity of the optical axis on the object-side surface 1021 of the second lens element 1020) and zero values for the a4˜a16 of the image-side surface 1012 of the first lens element 1010, but the refracting power and configuration of the concave/convex shape of the lens elements (comprising the object-side surfaces 1011-1031˜1041 facing to the object side A1 and the image-side surfaces 1012˜1042 facing to the image side A2), surfaces 1051, 1052 and image plane 1060 are similar to those in the first embodiment. Please refer to FIG. 40 for the optical characteristics of each lens elements in the optical imaging lens 10 of the present embodiment, wherein the values of T1/G12, T4/G34, T3/T2, G23/G12, T4/T2, (G23+G34)/G12 and Gaa/T2 are:

T1/G12=13.46, satisfying equation (1);

T4/G34=3.04, satisfying equation (2);

T3/T2=1.65, satisfying equation (3);

G23/G12=12.40, satisfying equation (4);

T4/T2=2.69, satisfying equation (5), (5′);

(G23+G34)/G12=16.96, satisfying equation (6);

Gaa/T2=3.49, satisfying equation (7);

wherein the distance from the object side surface 1011 of the first lens element 1010 to the image plane 1060 on the optical axis is 3.12 (mm) and the length of the optical imaging lens 10 is shortened.

As shown in FIG. 39, the optical imaging lens 10 of the present embodiment shows great characteristics in longitudinal spherical aberration (a), astigmatism in the sagittal direction (b), astigmatism in the tangential direction (c), and distortion aberration (d). Therefore, according to the above illustration, the optical imaging lens of the present embodiment indeed shows great optical performance and the length of the optical imaging lens 10 is effectively shortened.

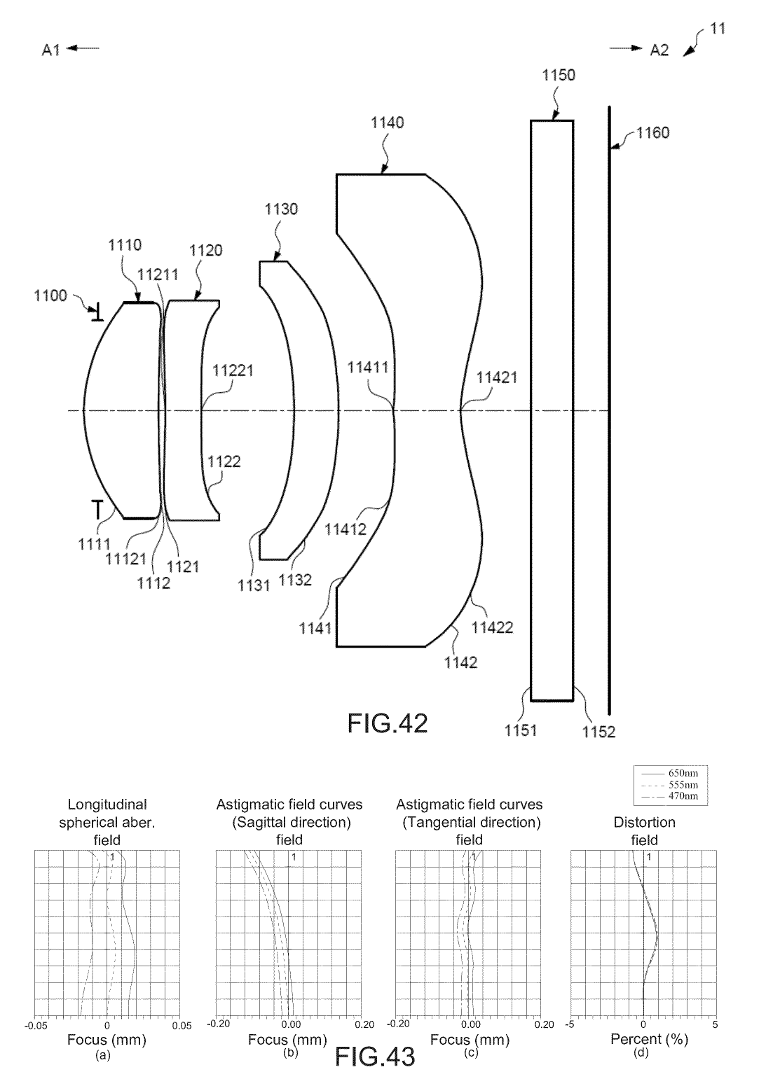

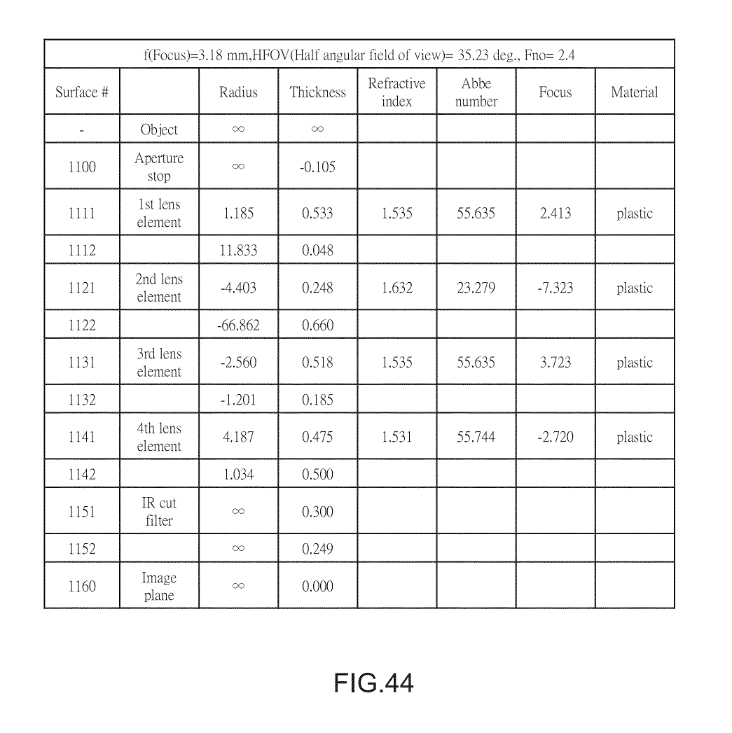

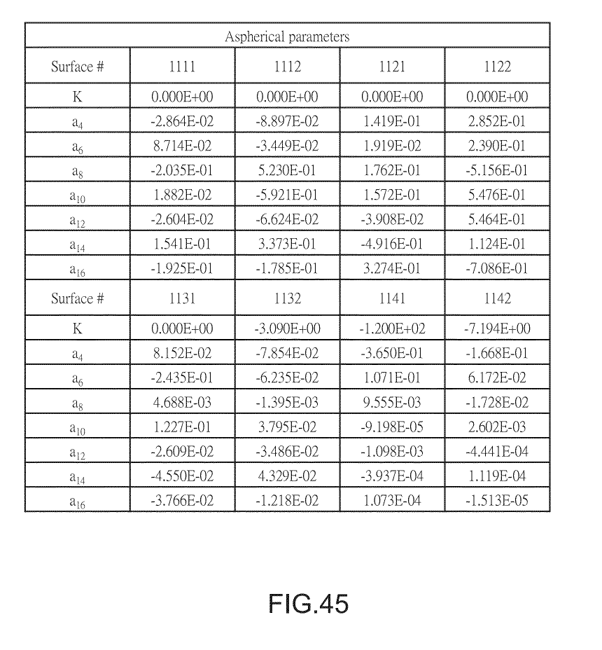

Reference is now made to FIGS. 42-45. FIG. 42 illustrates an example cross-sectional view of an optical imaging lens 11 having four lens elements of the optical imaging lens according to a eleventh example embodiment. FIG. 43 shows example charts of longitudinal spherical aberration and other kinds of optical aberrations of the optical imaging lens 11 according to the eleventh example embodiment. FIG. 44 shows an example table of optical data of each lens element of the optical imaging lens 11 according to the eleventh example embodiment. FIG. 45 shows an example table of aspherical data of the optical imaging lens 11 according to the eleventh example embodiment. The reference numbers labeled in the present embodiment are similar to those in the first embodiment for the similar elements, but here the reference numbers are initialed with 11, for example, reference number 1111 for labeling the object-side surface of the first lens element 1110, reference number 1112 for labeling the image-side surface of the first lens element 1110, etc.

As shown in FIG. 42, the optical imaging lens 11 of the present embodiment, in an order from an object side A1 to an image side A2, comprises an aperture stop 1100 positioned in front of a first lens element 1110, the first lens element 1110, a second lens element 1120, a third lens element 1130, and a fourth lens element 1140.

The differences between the eleventh embodiment and the first embodiment are the radius, thickness of each lens element, the distance of each air gap and configuration of some concave/convex shape of some lens element (comprising a convex portion 11121 in a vicinity of a periphery of the first lens element 1110 on the image-side surface 1112 thereof, a concave portion 11211 in a vicinity of a periphery of the second lens element 1120 on the object-side surface 1121 thereof and a convex portion 11221 in a vicinity of the optical axis on the image-side surface 1122 of the second lens element 1120), but the refracting power and configuration of the concave/convex shape of the lens elements (comprising the object-side surfaces 1111-1131˜1141 facing to the object side A1 and the image-side surfaces 1132˜1142 facing to the image side A2), surfaces 1151, 1152 and image plane 1160 are similar to those in the first embodiment. Please refer to FIG. 44 for the optical characteristics of each lens elements in the optical imaging lens 11 of the present embodiment, wherein the values of T1/G12, T4/G34, T3/T2, G23/G12, T4/T2, (G23+G34)/G12 and Gaa/T2 are:

T1/G12=11.06, satisfying equation (1);

T4/G34=2.56, satisfying equation (2);

T3/T2=2.09, satisfying equation (3);

G23/G12=13.67, satisfying equation (4);

T4/T2=1.92, satisfying equation (5), (5′);

(G23+G34)/G12=17.51, satisfying equation (6);

Gaa/T2=3.61, satisfying equation (7);

wherein the distance from the object side surface 1111 of the first lens element 1110 to the image plane 1160 on the optical axis is 3.72 (mm) and the length of the optical imaging lens 11 is shortened.

As shown in FIG. 43, the optical imaging lens 11 of the present embodiment shows great characteristics in longitudinal spherical aberration (a), astigmatism in the sagittal direction (b), astigmatism in the tangential direction (c), and distortion aberration (d). Therefore, according to the above illustration, the optical imaging lens of the present embodiment indeed shows great optical performance and the length of the optical imaging lens 11 is effectively shortened.

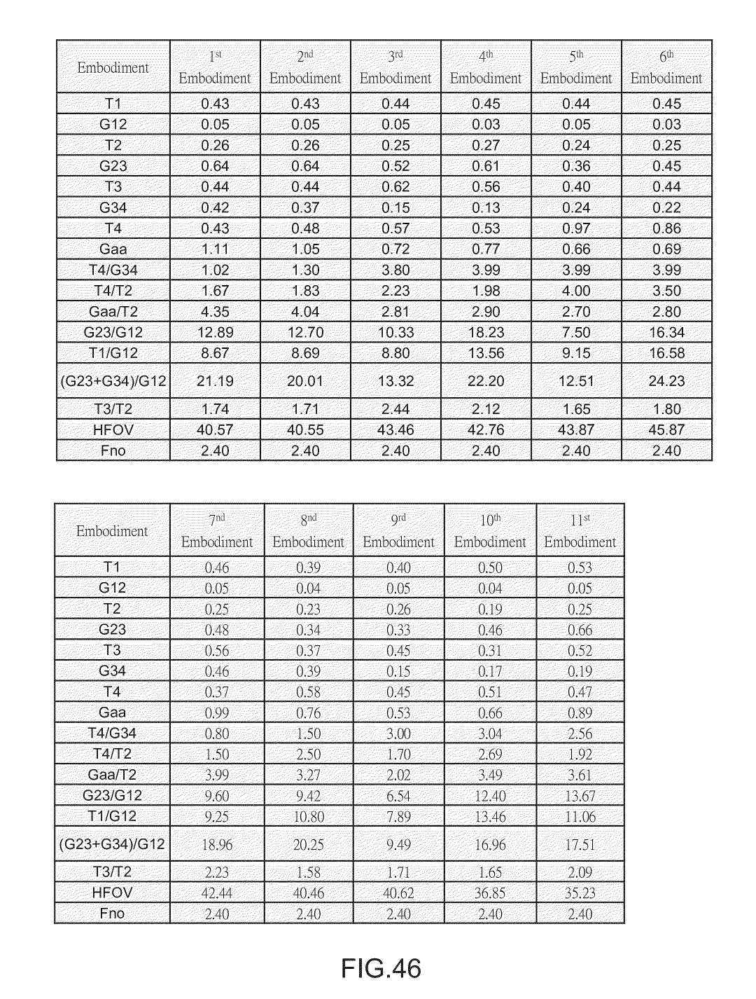

Please refer to FIG. 46, which shows the values of T1, G12, T2, G23, T3, G34, T4, Gaa, T4/G34, T4/T2, Gaa/T2, G23/G12, T1/G12, (G23+G34)/G12 and T3/T2 of all eleven embodiments, and it is clear that the optical imaging lens of the present invention satisfy the Equations (1), (2), (3), (4), (5)/(5′), (6), and/or (7).

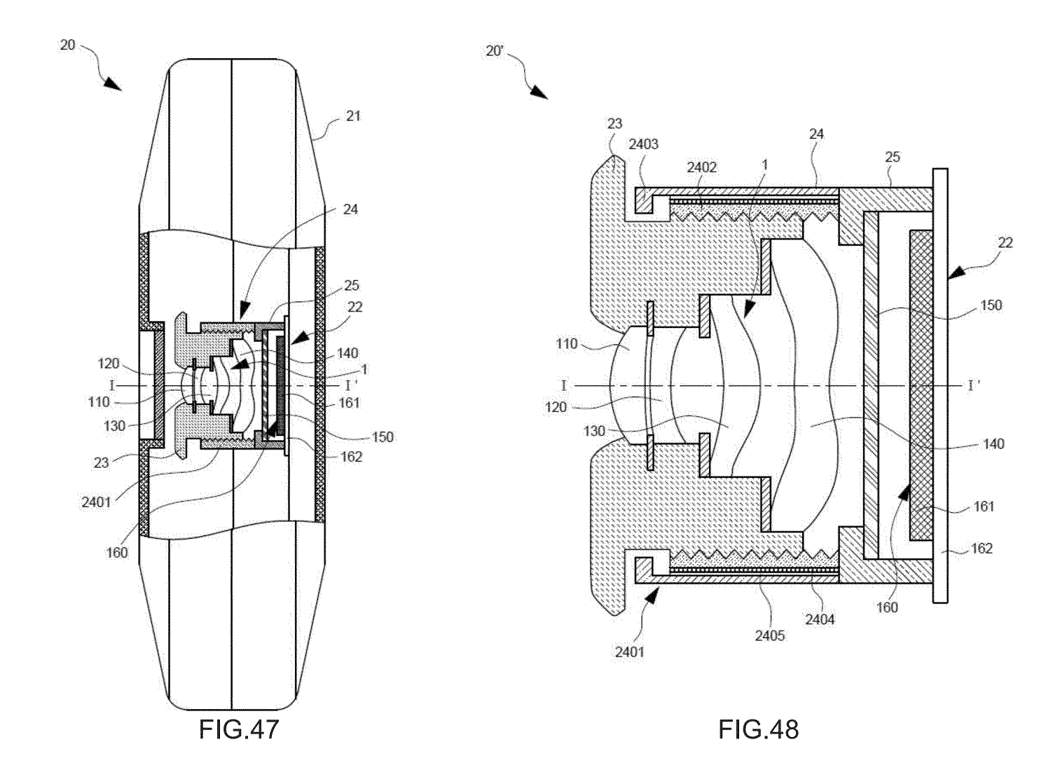

Reference is now made to FIG. 47, which illustrates an example structural view of a first embodiment of mobile device 20 applying an aforesaid optical imaging lens. The mobile device 20 comprises a housing 21 and a photography module 22 positioned in the housing 21. An example of the mobile device 20 may be, but is not limited to, a mobile phone.

As shown in FIG. 47, the photography module 22 may comprise an aforesaid optical imaging lens with four lens elements, for example the optical imaging lens 1 of the first embodiment, a lens barrel 23 for positioning the optical imaging lens 1, a module housing unit 24 for positioning the lens barrel 23, a substrate 162 for positioning the module housing unit 24, and an image sensor 161 which is positioned at an image side of the optical imaging lens 1. The image plane 160 is formed on the image sensor 161.

In some other example embodiments, the structure of the filtering unit 150 may be omitted. In some example embodiments, the housing 21, the lens barrel 23, and/or the module housing unit 24 may be integrated into a single component or assembled by multiple components. In some example embodiments, the image sensor 161 used in the present embodiment is directly attached to a substrate 162 in the form of a chip on board (COB) package, and such package is different from traditional chip scale packages (CSP) since COB package does not require a cover glass before the image sensor 161 in the optical imaging lens 1. Aforesaid exemplary embodiments are not limited to this package type and could be selectively incorporated in other described embodiments.

The four lens elements 110, 120, 130, 140 are positioned in the lens barrel 23 in the way of separated by an air gap between any two adjacent lens elements.

The module housing unit 24 comprises a seat element 2401 for positioning the lens barrel 23 and an image sensor base 25 positioned between the lens backseat 2401 and the image sensor 161. The lens barrel 23 and the seat element 2401 are positioned along a same axis I-I′, and the lens barrel 23 is positioned inside the seat element 2401. The sensor backseat 2406 is exemplarily close to the image sensor base 25 here. The image sensor base 25 could be optionally omitted in some other embodiments of the present invention.

Because the length of the optical imaging lens 1 is merely 3.75 (mm), the size of the mobile device 20 may be quite small. Therefore, the embodiments described herein meet the market demand for smaller sized product designs.

Reference is now made to FIG. 48, which shows another structural view of a second embodiment of mobile device 20′ applying the aforesaid optical imaging lens 1. One difference between the mobile device 20′ and the mobile device 20 may be the seat element 2401 comprises a first seat unit 2402, a second seat unit 2403, a coil 2404, and a magnetic unit 2405. Here, the seat element 2401 could move along the optical axis of the optical imaging lens 1. The first seat unit 2402 is close to the outside of the lens barrel 23, and positioned along an axis I-I′, and the second seat unit 2403 is around the outside of the first seat unit 2402 and positioned along with the axis I-I′. The coil 2404 is positioned between the first seat unit 2402 and the inside of the second seat unit 2403. The magnetic unit 2405 is positioned between the outside of the coil 2404 and the inside of the second seat unit 2403. The image-side of the image sensor base 25 is close to the second seat element 2403.

The lens barrel 23 and the optical imaging lens 1 positioned therein are driven by the first seat unit 2402 for moving along the axis I-I′. The rest structure of the mobile device 20′ is similar to the mobile device 20.

Similarly, because the length of the optical imaging lens 1, 3.75 (mm), is shortened, the mobile device 20′ may be designed with a smaller size and meanwhile good optical performance is still provided. Therefore, the present embodiment meets the demand of small sized product design and the request of the market.

According to above illustration, it is clear that the mobile device and the optical imaging lens thereof in example embodiments, through controlling ratio of a sum of central thickness of all four lens elements to air gaps between the first and second lens elements along the optical axis to in a predetermined range, and incorporated with detail structure and/or reflection power of the lens elements, the length of the optical imaging lens is effectively shortened and meanwhile good optical characters are still provided.

While various embodiments in accordance with the disclosed principles have been described above, it should be understood that they have been presented by way of example only, and are not limiting. Thus, the breadth and scope of exemplary embodiment(s) should not be limited by any of the above-described embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically, a description of a technology in the “Background” is not to be construed as an admission that technology is prior art to any invention(s) in this disclosure. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings herein.

What is claimed is:

1. An optical imaging lens, sequencially from an object side to an image side, comprising first, second, third and fourth lens elements, each of said first, second, third and fourth lens elements having an object-side surface facing toward the object side and an image-side surface facing toward the image side, wherein:
said first lens element has positive refracting power, said object-side surface thereof is a convex surface, and said image-side thereof comprises a concave portion in a vicinity of the optical axis;
said second lens element has negative refracting power, and said object-side surface thereof comprises a convex portion in a vicinity of a periphery of the second lens element;
said image-side surface of said third lens element comprises a convex portion in a vicinity of a periphery of the third lens element;
said object-side surface of said fourth lens element comprises a convex portion in a vicinity of the optical axis, and said image-side surface of said fourth lens element comprises a concave portion in a vicinity of the optical axis and a convex portion in a vicinity of a periphery of the fourth lens element; and
lens as a whole has only the four lens elements having refracting power.

2. The optical imaging lens according to claim 1, wherein a central thickness of the first lens element along the optical axis is T1, an air gap between the first lens element and the second lens element along the optical axis is G12, and T1 and G12 satisfy the equation:
5≦T1/G12.

3. The optical imaging lens according to claim 2, wherein a central thickness of the fourth lens element along the optical axis is T4, an air gap between the third lens element and the fourth lens element along the optical axis is G34, and T4 and G34 satisfy the equation:
T4/G34≦4.

4. The optical imaging lens according to claim 3, wherein a central thickness of the second lens element along the optical axis is T2, a central thickness of the third lens element along the optical axis is T3, and T2 and T3 satisfy the equation:
1.55≦T3/T2.

5. The optical imaging lens according to claim 4, wherein an air gap between the second lens element and the third lens element along the optical axis is G23, and G12 and G23 satisfy the equation:
3≦G23/G12.

6. The optical imaging lens according to claim 4, wherein T2 and T4 satisfy the equation:
1.8≦T4/T2.

7. The optical imaging lens according to claim 2, wherein a central thickness of the second lens element along the optical axis is T2, a central thickness of the fourth lens element along the optical axis is T4, and T2 and T4 satisfy the equation:
1.45≦T4/T2.

8. The optical imaging lens according to claim 7, wherein an air gap between the second lens element and the third lens element along the optical axis is G23, an air gap between the third lens element and the fourth lens element along the optical axis is G34, and G12, G23 and G34 satisfy the equation:
7.5≦(G23+G34)/G12.

9. The optical imaging lens according to claim 8, wherein T2 and T4 further satisfy the equation:
1.8≦T4/T2.

10. The optical imaging lens according to claim 1, wherein a central thickness of the second lens element along the optical axis is T2, a central thickness of the fourth lens element along the optical axis is T4, and T2 and T4 satisfy the equation:
1.45≦T4/T2.

11. The optical imaging lens according to claim 10, wherein a central thickness of the third lens element along the optical axis is T3, and T2 and T3 satisfy the equation:
1.55≦T3/T2.

12. The optical imaging lens according to claim 11, wherein T2 and T4 satisfy the equation:
1.8≦T4/T2.

13. The optical imaging lens according to claim 1, wherein said image-side surface of the first lens element comprises a concave portion in a vicinity of a periphery of the first lens element.

14. The optical imaging lens according to claim 13, wherein an air gap between the first lens element and the second lens element along the optical axis is G12, an air gap between the second lens element and the third lens element along the optical axis is G23, an air gap between the third lens element and the fourth lens element along the optical axis is G34, and G12, G23 and G34 satisfy the equation:
7.5≦(G23+G34)/G12.

15. The optical imaging lens according to claim 14, wherein the sum of all three air gaps from the first lens element to the fourth lens element along the optical axis is Gaa, a central thickness of the second lens element along the optical axis is T2, and Gaa and T2 satisfy the equation:
3.2≦Gaa/T2.

16. A mobile device, comprising:
a housing; and
a photography module positioned in the housing and comprising:
the optical imaging lens as claimed in claims 1;
a lens barrel for positioning the optical imaging lens;
a module housing unit for positioning the lens barrel; and
an image sensor positioned at the image side of the optical imaging lens.

17. The mobile device according to claim 16, wherein the module housing unit comprises a lens backseat comprising a first seat element and a second seat element, the first seat element is positioned close to the outside of the lens barrel and along with an axis for driving the lens barrel and the optical imaging lens positioned therein to move along the axis, and the second seat element is positioned along the axis and around the outside of the first seat element.

18. The mobile device according to claim 17, wherein the module housing unit further comprises an image sensor base positioned between the second seat element and the image sensor, and the image sensor base is closed to the second seat element.
